(19) United States
(12) Patent Application Publication
(10) Pub. No.: US 2022/0070614 A1
(43) Pub. Date: Mar. 3, 2022

(54) METHOD FOR MEASURING, BY FIRST TERMINAL, DISTANCE BETWEEN FIRST TERMINAL AND SECOND TERMINAL IN WIRELESS COMMUNICATION SYSTEM, AND TERMINAL THEREFOR

(71) Applicant: LG ELECTRONICS INC., Seoul (KR)

(72) Inventors: Seungmin LEE, Seoul (KR); Hyukjin CHAE, Seoul (KR); Hyunsu CHA, Seoul (KR)

(73) Assignee: LG ELECTRONICS INC., Seoul (KR)

(21) Appl. No.: 17/309,907

(22) PCT Filed: Dec. 31, 2019
(86) PCT No.: PCT/KR2019/018802

§ 371 Date: Jun. 28, 2021

(30) Foreign Application Priority Data
Dec. 31, 2018 (KR) 10-2018-0174264

(51) Int. Cl. H04W 4/02; G01S 5/12

(52) U.S. Cl. CPC H04W 4/023; G01S 5/12

(57) ABSTRACT

One embodiment relates to a method for measuring, by a first terminal, a distance between the first terminal and a second terminal and positions thereof in a wireless communication system, the method comprising the steps of: receiving, by a first terminal, a first signal and a second signal from a second terminal; and measuring, by the first terminal, a distance between the first terminal and the second terminal on the basis of the first signal and the second signal, wherein the distance is measured on the basis of a first transmitting angle, a second transmitting angle, a first receiving angle, a second receiving angle, and a difference between a first receiving time when the first terminal receives the first signal and a second receiving time when the first terminal receives the second signal.

### TECHNICAL FIELD

The present disclosure relates to a wireless communication system, and more particularly to a method for measuring a distance between a first user equipment (UE) and a second user equipment (UE) by the first UE in a wireless communication system, and a user equipment (UE) for measuring the distance.

### BACKGROUND ART

As more and more communication devices demand larger communication capacities, the need for enhanced mobile broadband communication relative to the legacy radio access technologies (RATs) has emerged. Massive machine type communication (mMTC) that provides various services by interconnecting multiple devices and things irrespective of time and place is also one of main issues to be addressed for future-generation communications. A communication system design considering services/user equipments (UEs) sensitive to reliability and latency is under discussion as well. As such, the introduction of a future-generation RAT considering enhanced mobile broadband (eMBB), mMTC, ultra-reliability and low latency communication (URLLC), and so on is being discussed. For convenience, this technology is referred to as new RAT (NR) in the present disclosure. NR is an exemplary 5th generation (5G) RAT.

A new RAT system including NR adopts orthogonal frequency division multiplexing (OFDM) or a similar transmission scheme. The new RAT system may use OFDM parameters different from long term evolution (LTE) OFDM parameters. Further, the new RAT system may have a larger system bandwidth (e.g., 100 MHz), while following the legacy LTE/LTE-advanced (LTE-A) numerology. Further, one cell may support a plurality of numerologies in the new RAT system. That is, UEs operating with different numerologies may co-exist within one cell.

Vehicle-to-everything (V2X) is a communication technology of exchanging information between a vehicle and another vehicle, a pedestrian, or infrastructure. V2X may cover four types of communications such as vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

### DISCLOSURE

### Technical Problem

An object of the present disclosure is to provide a method for estimating the position of a UE using multi-path fading of radio frequency (RF) signals.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solutions

In accordance with an aspect of the present disclosure, a method for measuring a distance between a first user equipment (UE) and a second user equipment (UE) as well as a position of the second user equipment (UE) by the first user equipment (UE) in a wireless communication system may include receiving, by the first user equipment (UE), a first signal and a second signal from the second user equipment (UE); and measuring, by the first user equipment (UE), the distance between the second user equipment (UE) and the first user equipment (UE) based on the first signal and the second signal. The distance may be measured based on a first transmission angle, a second transmission angle, a first reception angle, a second reception angle, and a time difference between a first reception time point where the first user equipment (UE) receives the first signal and a second reception time point where the first user equipment (UE) receives the second signal.′

In accordance with another aspect of the present disclosure, a first user equipment (UE) for measuring a distance between the first user equipment (UE) and the second user equipment (UE) as well as a position of the second position in a wireless communication system may include a memory, and a processor connected to the memory. The processor may be configured to receive a first signal and a second signal from the second user equipment (UE), and to measure the distance between the second user equipment (UE) and the first user equipment (UE) based on the first signal and the second signal. The distance may be measured based on a first transmission angle, a second transmission angle, a first reception angle, a second reception angle, and a time difference between a first reception time point where the first user equipment (UE) receives the first signal and a second reception time point where the first user equipment (UE) receives the second signal.

The first transmission angle may be an angle between a first reference axis and a path along which the first signal is transmitted from the second user equipment (UE). The second transmission angle may be an angle between the first reference axis and a path along which the second signal is transmitted from the second user equipment (UE). The first reception angle may be an angle between a second reference axis and a path along which the first signal is received by the first user equipment (UE). The second reception angle may be an angle between the second reference axis and a path along which the second signal is received by the first user equipment (UE).

The distance may be measured using a following equation:

$$d = \frac{c \cdot {t}_{0 , 1}}{\frac{sin ( {θ}_{T , 0} - {θ}_{T , 1} ) + sin ( {θ}_{R , 0} - {θ}_{R , 1} )}{sin ( π - ( {θ}_{T , 0} - {θ}_{T , 1} + {θ}_{R , 0} - {θ}_{R , 1} ) )} - 1} \qquad [ Equation ]$$

where, c is a speed of light, t_{0,1} is a time difference between the first reception time point and the second reception time point, θ_{T,0} is the first transmission angle, θ_{T,1} is the second transmission angle, θ_{R,0} is the first reception angle, and θ_{R,1} is the second reception angle.

If the first signal and the second signal are transmitted along a none-line-of-sight (NLOS) path, the first user equipment (UE) may consider that the second signal is transmitted along a line-of-sight (LOS) path, and a predetermined offset may be applied to the distance.

The offset may be determined differently according to an angle-of-arrival (AoA) value or an angle-of-departure (AoD) value.

The first signal may be transmitted along a none-line-of-sight (NLOS) path, and the second signal may be transmitted along a line-of-sight (LOS) path.

Information about whether the first signal and the second signal may be transmitted along a line-of-sight (LOS) path is determined through phase distribution of channel components related to a positioning reference signal (PRS).

The method may further include receiving, by the first user equipment (UE), information indicating either a first reference axis or a second reference axis from the second user equipment (UE), or transmitting, by the first user equipment (UE), information indicating either the first reference axis or the second reference axis to the second user equipment (UE).

The method may further include, if the first user equipment (UE) does not acquire the first transmission angle or the second transmission angle, transmitting, by the first user equipment (UE), a feedback signal including information about the first reception angle and information about the second reception angle to the second user equipment (UE), wherein the distance is measured by the second user equipment (UE).

The first user equipment (UE) may be configured to communicate with at least one of a mobile user equipment (UE), a network, and an autonomous vehicle other than the device.

The first user equipment (UE) may be configured to implement at least one advanced driver assistance system (ADAS) function based on a signal for controlling movement of the first user equipment (UE).

The first user equipment (UE) may receive a user input signal from a user, may switch a driving mode of the device from an autonomous driving mode to a manual driving mode, or may switch a driving mode of the device from the manual driving mode to the autonomous driving mode.

The first user equipment (UE) may be autonomously driven based on external object information, wherein the external object information includes at least one of information indicating presence or absence of an object, position information of the object, information about a distance between the first user equipment (UE) and the object, and information about a relative speed between the first user equipment (UE) and the object.

### Advantageous Effects

The embodiments of the present disclosure can provide a method for efficiently performing UE ranging by measuring AoA and/or AoD.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### DESCRIPTION OF DRAWINGS

The accompanying drawings, which are included to provide a further understanding of embodiment(s), illustrate various embodiments and together with the description of the specification serve to explain the principle of the specification.

FIG. 1 illustrates a frame structure in new radio (NR).

FIG. 2 illustrates a radio grid in NR.

FIG. 3 illustrates sidelink synchronization.

FIG. 4 illustrates a time resource unit for transmitting a sidelink synchronization signal.

FIG. 5 is a view illustrating an exemplary resource pool for sidelink.

FIG. 6 is a view referred to for describing transmission modes and scheduling schemes for sidelink.

FIG. 7 is a view illustrating a method of selecting resources in sidelink.

FIG. 8 illustrates transmission of a physical sidelink control channel (PSCCH).

FIG. 9 illustrates PSCCH transmission in sidelink vehicle-to-everything (V2X) communication.

FIG. 10 is a conceptual diagram illustrating a partial array structure to which an ESPRIT algorithm is applied.

FIG. 11 is a conceptual diagram illustrating the method according to the present disclosure.

FIG. 12 is a conceptual diagram illustrating the method according to the present disclosure.

FIG. 13 is a conceptual diagram illustrating the method according to the present disclosure.

FIG. 14 is a diagram illustrating a communication system to which one embodiment of the present disclosure can be applied.

FIG. 15 is a block diagram illustrating a wireless device to which one embodiment of the present disclosure can be applied.

FIG. 16 is a block diagram illustrating a signal processing circuit for transmission (Tx) signals to which one embodiment of the present disclosure can be applied.

FIG. 17 is a block diagram illustrating a wireless device to which another embodiment of the present disclosure can be applied.

FIG. 18 is a block diagram illustrating a hand-held device to which another embodiment of the present disclosure can be applied.

FIG. 19 is a block diagram illustrating a vehicle or an autonomous driving vehicle to which another embodiment of the present disclosure can be applied.

FIG. 20 is a block diagram illustrating a vehicle to which another embodiment of the present disclosure can be applied.

### BEST MODE

In this document, downlink (DL) communication refers to communication from a base station (BS) to a user equipment (UE), and uplink (UL) communication refers to communication from the UE to the BS. In DL, a transmitter may be a part of the BS and a receiver may be a part of the UE. In UL, a transmitter may be a part of the UE and a receiver may be a part of the BS. Herein, the BS may be referred to as a first communication device, and the UE may be referred to as a second communication device. The term ‘BS’ may be replaced with ‘fixed station’, ‘Node B’, ‘evolved Node B (eNB)’, ‘next-generation node B (gNB)’, ‘base transceiver system (BTS)’, ‘access point (AP)’, ‘network node’, ‘fifth-generation (5G) network node’, ‘artificial intelligence (AI) system’, ‘road side unit (RSU)’, ‘robot’, etc. The term ‘UE’ may be replaced with ‘terminal’, ‘mobile station (MS)’, ‘user terminal (UT)’, ‘mobile subscriber station (MSS)’, ‘subscriber station (SS)’, ‘advanced mobile station (AMS)’, ‘wireless terminal (WT)’, ‘machine type communication (MTC) device’, ‘machine-to-machine (M2M) device’, ‘device-to-device (D2D) device’, ‘vehicle’, ‘robot’, ‘AI module’, etc.

The technology described herein is applicable to various wireless access systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA may be implemented as radio technology such as universal terrestrial radio access (UTRA) or CDMA2000. The TDMA may be implemented as radio technology such as global system for mobile communications (GSM), general packet radio service (GPRS), or enhanced data rates for GSM evolution (EDGE). The OFDMA may be implemented as radio technology such as the Institute of Electrical and Electronics Engineers (IEEE) 802.11 (Wi-Fi), IEEE 802.16 (WiMAX), IEEE 802-20, evolved UTRA (E-UTRA), etc. The UTRA is a part of a universal mobile telecommunication system (UMTS). 3rd generation partnership project (3GPP) long term evolution (LTE) is a part of evolved UMTS (E-UMTS) using E-UTRA. LTE-advance (LTE-A) or LTE-A pro is an evolved version of 3GPP LTE. 3GPP new radio or new radio access technology (3GPP NR) is an evolved version of 3GPP LTE, LTE-A, or LTE-A pro.

Although the present disclosure is described based on 3GPP communication systems (e.g., LTE-A, NR, etc.) for clarity of description, the spirit of the present disclosure is not limited thereto. LTE refers to technologies beyond 3GPP technical specification (TS) 36.xxx Release 8. In particular, LTE technologies beyond 3GPP TS 36.xxx Release 10 are referred to as LTE-A, and LTE technologies beyond 3GPP TS 36.xxx Release 13 are referred to as LTE-A pro. 3GPP NR refers to technologies beyond 3GPP TS 38.xxx Release 15. LTE/NR may be called ‘3GPP system’. Herein, “xxx” refers to a standard specification number.

In the present disclosure, a node refers to a fixed point capable of transmitting/receiving a radio signal for communication with a UE. Various types of BSs may be used as the node regardless of the names thereof. For example, the node may include a BS, a node B (NB), an eNB, a pico-cell eNB (PeNB), a home eNB (HeNB), a relay, a repeater, etc. A device other than the BS may be the node. For example, a radio remote head (RRH) or a radio remote unit (RRU) may be the node. The RRH or RRU generally has a lower power level than that of the BS. At least one antenna is installed for each node. The antenna may refer to a physical antenna or mean an antenna port, a virtual antenna, or an antenna group. The node may also be referred to as a point.

In the present disclosure, a cell refers to a prescribed geographical area in which one or more nodes provide communication services or a radio resource. When a cell refers to a geographical area, the cell may be understood as the coverage of a node where the node is capable of providing services using carriers. When a cell refers to a radio resource, the cell may be related to a bandwidth (BW), i.e., a frequency range configured for carriers. Since DL coverage, a range within which the node is capable of transmitting a valid signal, and UL coverage, a range within which the node is capable of receiving a valid signal from the UE, depend on carriers carrying the corresponding signals, the coverage of the node may be related to the coverage of the cell, i.e., radio resource used by the node. Accordingly, the term “cell” may be used to indicate the service coverage of a node, a radio resource, or a range to which a signal transmitted on a radio resource can reach with valid strength.

In the present disclosure, communication with a specific cell may mean communication with a BS or node that provides communication services to the specific cell. In addition, a DL/UL signal in the specific cell refers to a DL/UL signal from/to the BS or node that provides communication services to the specific cell. In particular, a cell providing DL/UL communication services to a UE may be called a serving cell. The channel state/quality of the specific cell may refer to the channel state/quality of a communication link formed between the BS or node, which provides communication services to the specific cell, and the UE.

When a cell is related to a radio resource, the cell may be defined as a combination of DL and UL resources, i.e., a combination of DL and UL component carriers (CCs). The cell may be configured to include only DL resources or a combination of DL and UL resources. When carrier aggregation is supported, a linkage between the carrier frequency of a DL resource (or DL CC) and the carrier frequency of a UL resource (or UL CC) may be indicated by system information transmitted on a corresponding cell. The carrier frequency may be equal to or different from the center frequency of each cell or CC. A cell operating on a primary frequency may be referred to as a primary cell (Pcell) or PCC, and a cell operating on a secondary frequency may be referred to as a secondary cell (Scell) or SCC. The Scell may be configured after the UE and BS establish a radio resource control (RRC) connection therebetween by performing an RRC connection establishment procedure, that is, after the UE enters the RRC CONNECTED state. The RRC connection may mean a path that enables the RRC of the UE and the RRC of the BS to exchange an RRC message. The Scell may be configured to provide additional radio resources to the UE. The Scell and the Pcell may form a set of serving cells for the UE depending on the capabilities of the UE. When the UE is not configured with carrier aggregation or does not support the carrier aggregation although the UE is in the RRC CONNECTED state, only one serving cell configured with the Pcell exists.

A cell supports a unique radio access technology (RAT). For example, transmission/reception in an LTE cell is performed based on the LTE RAT, and transmission/reception in a 5G cell is performed based on the 5G RAT.

The carrier aggregation is a technology for combining a plurality of carriers each having a system BW smaller than a target BW to support broadband. The carrier aggregation is different from OFDMA in that in the former, DL or UL communication is performed on a plurality of carrier frequencies each forming a system BW (or channel BW) and in the latter, DL or UL communication is performed by dividing a base frequency band into a plurality of orthogonal subcarriers and loading the subcarriers in one carrier frequency. For example, in OFDMA or orthogonal frequency division multiplexing (OFDM), one frequency band with a predetermined system BW is divided into a plurality of subcarriers with a predetermined subcarrier spacing, and information/data is mapped to the plurality of subcarriers. Frequency up-conversion is applied to the frequency band to which the information/data is mapped, and the information/data is transmitted on the carrier frequency in the frequency band. In wireless carrier aggregation, multiple frequency bands, each of which has its own system BW and carrier frequency, may be simultaneously used for communication, and each frequency band used in the carrier aggregation may be divided into a plurality of subcarriers with a predetermined subcarrier spacing.

3GPP communication specifications define DL physical channels corresponding to resource elements carrying information originating from higher (upper) layers of physical layers (e.g., a medium access control (MAC) layer, a radio link control (RLC) layer, a protocol data convergence protocol (PDCP) layer, an RRC layer, a service data adaptation protocol (SDAP) layer, a non-access stratum (NAS) layer, etc.) and DL physical signals corresponding to resource elements which are used by physical layers but do not carry information originating from higher layers. For example, a physical downlink shared channel (PDSCH), a physical broadcast channel (PBCH), a physical multicast channel (PMCH), a physical control format indicator channel (PCFICH), and a physical downlink control channel (PDCCH) are defined as the DL physical channels, and a reference signal and a synchronization signal are defined as the DL physical signals. A reference signal (RS), which is called a pilot signal, refers to a predefined signal with a specific waveform known to both the BS and UE. For example, a cell-specific RS (CRS), a UE-specific RS (UE-RS), a positioning RS (PRS), a channel state information RS (CSI-RS), and a demodulation reference signal (DMRS) may be defined as DL RSs. In addition, the 3GPP communication specifications define UL physical channels corresponding to resource elements carrying information originating from higher layers and UL physical signals corresponding to resource elements which are used by physical layers but do not carry information originating from higher layers. For example, a physical uplink shared channel (PUSCH), a physical uplink control channel (PUCCH), and a physical random access channel (PRACH) are defined as the UL physical channels, and a demodulation reference signal (DMRS) for a UL control/data signal and a sounding reference signal (SRS) used for UL channel measurement are defined as the UL physical signals.

In the present disclosure, the PDCCH and the PDSCH may refer to a set of time-frequency resources or resource elements carrying downlink control information (DCI) of the physical layer and a set of time-frequency resources or resource elements carrying DL data thereof, respectively. The PUCCH, the PUSCH, and the PRACH may refer to a set of time-frequency resources or resource elements carrying uplink control information (UCI) of the physical layer, a set of time-frequency resources or resource elements carrying UL data thereof, and a set of time-frequency resources or resource elements carrying random access signals thereof, respectively. When it is said that a UE transmits a UL physical channel (e.g., PUCCH, PUSCH, PRACH, etc.), it may mean that the UE transmits UCI, UL data, or a random access signal on or over the corresponding UL physical channel. When it is said that the BS receives a UL physical channel, it may mean that the BS receives UCI, UL data, a random access signal on or over the corresponding UL physical channel. When it is said that the BS transmits a DL physical channel (e.g., PDCCH, PDSCH, etc.), it may mean that the BS transmits DCI or UL data on or over the corresponding DL physical channel. When it is said that the UE receives a DL physical channel, it may mean that the UE receives DCI or UL data on or over the corresponding DL physical channel.

In the present disclosure, a transport block may mean the payload for the physical layer. For example, data provided from the higher layer or MAC layer to the physical layer may be referred to as the transport block.

In the present disclosure, hybrid automatic repeat request (HARQ) may mean a method used for error control. A HARQ acknowledgement (HARQ-ACK) transmitted in DL is used to control an error for UL data, and a HARQ-ACK transmitted in UL is used to control an error for DL data. A transmitter that performs the HARQ operation waits for an ACK signal after transmitting data (e.g. transport blocks or codewords). A receiver that performs the HARQ operation transmits an ACK signal only when the receiver correctly receives data. If there is an error in the received data, the receiver transmits a negative ACK (NACK) signal. Upon receiving the ACK signal, the transmitter may transmit (new) data but, upon receiving the NACK signal, the transmitter may retransmit the data. Meanwhile, there may be a time delay until the BS receives ACK/NACK from the UE and retransmits data after transmitting scheduling information and data according to the scheduling information. The time delay occurs due to a channel propagation delay or a time required for data decoding/encoding. Accordingly, if new data is transmitted after completion of the current HARQ process, there may be a gap in data transmission due to the time delay. To avoid such a gap in data transmission during the time delay, a plurality of independent HARQ processes are used. For example, when there are 7 transmission occasions between initial transmission and retransmission, a communication device may perform data transmission with no gap by managing 7 independent HARQ processes. When the communication device uses a plurality of parallel HARQ processes, the communication device may successively perform UL/DL transmission while waiting for HARQ feedback for previous UL/DL transmission.

In the present disclosure, CSI collectively refers to information indicating the quality of a radio channel (also called a link) created between a UE and an antenna port. The CSI includes at least one of a channel quality indicator (CQI), a precoding matrix indicator (PMI), a CSI-RS resource indicator (CRI), an SSB resource indicator (SSBRI), a layer indicator (LI), a rank indicator (RI), or a reference signal received power (RSRP).

In the present disclosure, frequency division multiplexing (FDM) may mean that signals/channels/users are transmitted/received on different frequency resources, and time division multiplexing (TDM) may mean that signals/channels/users are transmitted/received on different time resources.

In the present disclosure, frequency division duplex (FDD) refers to a communication scheme in which UL communication is performed on a UL carrier and DL communication is performed on a DL carrier linked to the UL carrier, and time division duplex (TDD) refers to a communication scheme in which UL and DL communication are performed by splitting time.

The details of the background, terminology, abbreviations, etc. used herein may be found in documents published before the present disclosure. For example, 3GPP TS 24 series, 3GPP TS 34 series, and 3GPP TS 38 series may be referenced (http://www.3gpp.org/specifications/specification-numbering).

Frame Structure

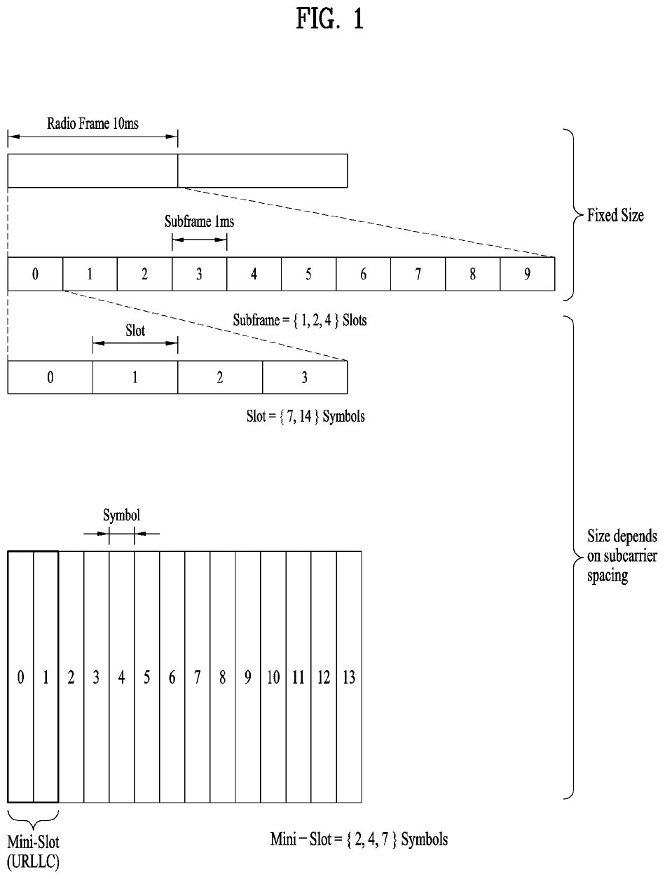

FIG. 1 is a diagram illustrating a frame structure in NR.

The NR system may support multiple numerologies. The numerology is defined by a subcarrier spacing and cyclic prefix (CP) overhead. A plurality of subcarrier spacings may be derived by scaling a basic subcarrier spacing by an integer N (or μ). The numerology may be selected independently of the frequency band of a cell although it is assumed that a small subcarrier spacing is not used at a high carrier frequency. In addition, the NR system may support various frame structures based on the multiple numerologies.

Hereinafter, an OFDM numerology and a frame structure, which may be considered in the NR system, will be described. Table 1 shows multiple OFDM numerologies supported in the NR system. The value of μ for a bandwidth part and a CP may be obtained by RRC parameters provided by the BS.

TABLE 1

| μ | Δf = 2^{μ}*15 [kHz] | Cyclic prefix(CP) |
|---|---|---|
| 0 | 15 | Normal |
| 1 | 30 | Normal |
| 2 | 60 | Normal, Extended |
| 3 | 120 | Normal |
| 4 | 240 | Normal |

The NR system supports multiple numerologies (e.g., subcarrier spacings) to support various 5G services. For example, the NR system supports a wide area in conventional cellular bands in a subcarrier spacing of 15 kHz and supports a dense urban environment, low latency, and wide carrier BW in a subcarrier spacing of 30/60 kHz. In a subcarrier spacing of 60 kHz or above, the NR system supports a BW higher than 24.25 GHz to overcome phase noise.

Resource Grid

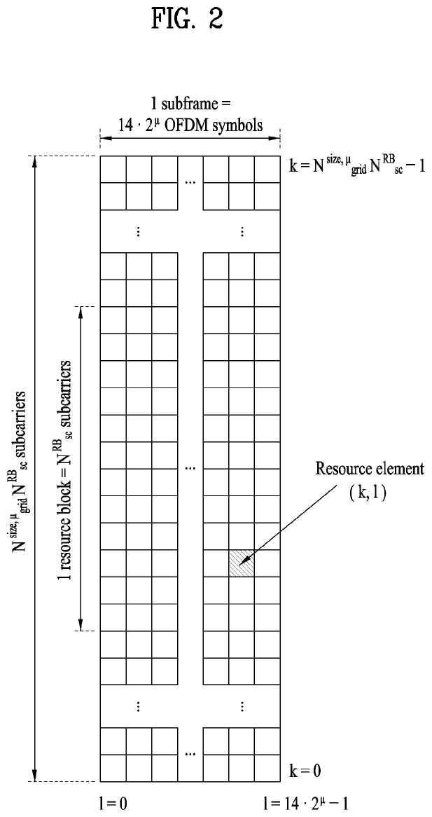

FIG. 2 illustrates a resource grid in the NR.

Referring to FIG. 2, a resource grid consisting of Nsize,μgrid*NRBsc subcarriers and 14*2μ, OFDM symbols may be defined for each subcarrier spacing configuration and carrier, where Nsize,μgrid is indicated by RRC signaling from the BS. Nsize,μgrid may vary not only depending on the subcarrier spacing configuration μ but also between UL and DL. One resource grid exists for the subcarrier spacing configuration μ, an antenna port p, and a transmission direction (i.e., UL or DL). Each element in the resource gird for the subcarrier spacing configuration μ and the antenna port p may be referred to as a resource element and identified uniquely by an index pair of (k, l), where k denotes an index in the frequency domain and l denotes the relative location of a symbol in the frequency domain with respect to a reference point. The resource element (k, l) for the subcarrier spacing configuration μ and the antenna port p may be a physical resource and a complex value, a(p,μ)k,l. A resource block (RB) is defined as NRBsc consecutive subcarriers in the frequency domain (where NRBsc=12).

Considering the point that the UE is incapable of supporting a wide BW supported in the NR system, the UE may be configured to operate in a part of the frequency BW of a cell (hereinafter referred to as a bandwidth part (BWP)).

Bandwidth Part (BWP)

The NR system may support up to 400 MHz for each carrier. If the UE always keeps a radio frequency (RF) module on for all carriers while operating on such a wideband carrier, the battery consumption of the UE may increase. Considering multiple use cases (e.g., eMBB, URLLC, mMTC, V2X, etc.) operating in one wideband carrier, a different numerology (e.g., subcarrier spacing) may be supported for each frequency band of the carrier. Further, considering that each UE may have a different capability regarding the maximum BW, the BS may instruct the UE to operate only in a partial BW rather than the whole BW of the wideband carrier. The partial bandwidth is referred to as the BWP. The BWP is a subset of contiguous common RBs defined for numerology μi in BWP i of the carrier in the frequency domain, and one numerology (e.g., subcarrier spacing, CP length, and/or slot/mini-slot duration) may be configured for the BWP.

The BS may configure one or more BWPs in one carrier configured for the UE. Alternatively, if UEs are concentrated in a specific BWP, the BS may move some UEs to another BWP for load balancing. For frequency-domain inter-cell interference cancellation between neighbor cells, the BS may configure BWPs on both sides of a cell except for some central spectra in the whole BW in the same slot. That is, the BS may configure at least one DL/UL BWP for the UE associated with the wideband carrier, activate at least one of DL/UL BWP(s) configured at a specific time (by L1 signaling which is a physical-layer control signal, a MAC control element (CE) which is a MAC-layer control signal, or RRC signaling), instruct the UE to switch to another configured DL/UL BWP (by L1 signaling, a MAC CE, or RRC signaling), or set a timer value and switch the UE to a predetermined DL/UL BWP upon expiration of the timer value. In particular, an activated DL/UL BWP is referred to as an active DL/UL BWP. While performing initial access or before setting up an RRC connection, the UE may not receive a DL/UL BWP configuration. A DL/UL BWP that the UE assumes in this situation is referred to as an initial active DL/UL BWP.

Synchronization Acquisition of Sidelink UE

In time division multiple access (TDMA) and frequency division multiple access (FDMA) systems, accurate time and frequency synchronization is essential. If time and frequency synchronization is not accurate, inter-symbol interference (ISI) and inter-carrier interference (ICI) may occur so that system performance may be degraded. This may occur in V2X. For time/frequency synchronization in V2X, a sidelink synchronization signal (SLSS) may be used in the physical layer, and master information block-sidelink-V2X (MIB-SL-V2X) may be used in the RLC layer.

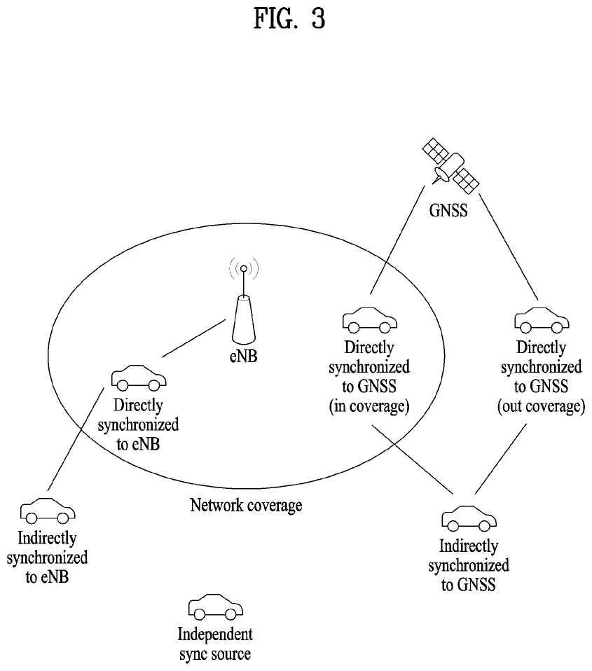

FIG. 3 illustrates a synchronization source and a synchronization reference in V2X.

Referring to FIG. 3, in V2X, a UE may be directly synchronized to global navigation satellite systems (GNSS) or indirectly synchronized to the GNSS through another UE (in or out of the network coverage) that is directly synchronized to the GNSS. When the GNSS is set to the synchronization source, the UE may calculate a direct frame number (DFN) and a subframe number based on coordinated universal time (UTC) and a (pre)configured DFN offset.

Alternatively, the UE may be directly synchronized to the BS or synchronized to another UE that is time/frequency synchronized to the BS. For example, if the UE is in the coverage of the network, the UE may receive synchronization information provided by the BS and be directly synchronized to the BS. Thereafter, the UE may provide the synchronization information to another adjacent UE. If the timing of the BS is set to the synchronization reference, the UE may follow a cell associated with a corresponding frequency (if the UE is in the cell coverage at the corresponding frequency) or follow a Pcell or serving cell (if the UE is out of the cell coverage at the corresponding frequency) for synchronization and DL measurement.

The serving cell (BS) may provide a synchronization configuration for carriers used in V2X sidelink communication. In this case, the UE may follow the synchronization configuration received from the BS. If the UE detects no cell from the carriers used in the V2X sidelink communication and receives no synchronization configuration from the serving cell, the UE may follow a predetermined synchronization configuration.

Alternatively, the UE may be synchronized to another UE that fails to directly or indirectly obtain the synchronization information from the BS or GNSS. The synchronization source and preference may be preconfigured for the UE or configured in a control message from the BS.

Hereinbelow, the SLSS and synchronization information will be described.

The SLSS may be a sidelink-specific sequence and include a primary sidelink synchronization signal (PSSS) and a secondary sidelink synchronization signal (SSSS).

Each SLSS may have a physical layer sidelink synchronization identity (ID), and the value may be, for example, any of 0 to 335. The synchronization source may be identified depending on which of the above values is used. For example, 0, 168, and 169 may indicate the GNSS, 1 to 167 may indicate the BS, and 170 to 335 may indicate out-of-coverage. Alternatively, among the values of the physical layer sidelink synchronization ID, 0 to 167 may be used by the network, and 168 to 335 may be used for the out-of-coverage state.

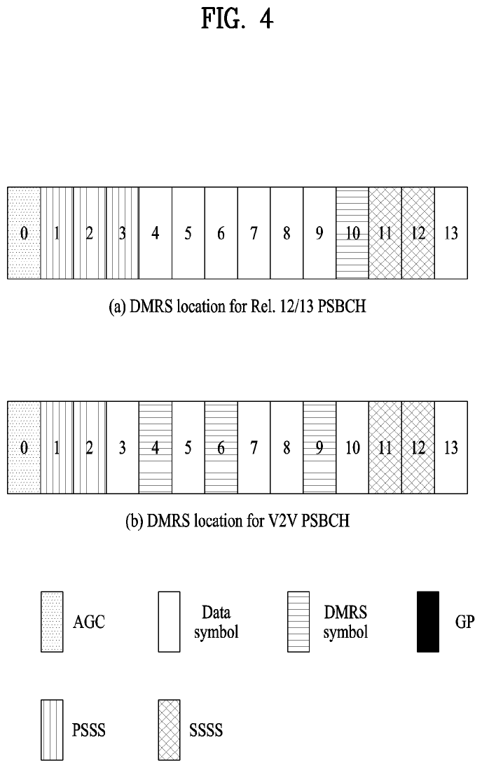

FIG. 4 illustrates a time resource unit for SLSS transmission. The time resource unit may be a subframe in LTE/LTE-A and a slot in 5G. The details may be found in 3GPP TS 36 series or 3GPP TS 28 series. A physical sidelink broadcast channel (PSBCH) may refer to a channel for carrying (broadcasting) basic (system) information that the UE needs to know before sidelink signal transmission and reception (e.g., SLSS-related information, a duplex mode (DM), a TDD UL/DL configuration, information about a resource pool, the type of an SLSS-related application, a subframe offset, broadcast information, etc.). The PSBCH and SLSS may be transmitted in the same time resource unit, or the PSBCH may be transmitted in a time resource unit after that in which the SLSS is transmitted. A DMRS may be used to demodulate the PSBCH.

Sidelink Transmission Mode

For sidelink communication, transmission modes 1, 2, 3 and 4 are used.

In transmission mode 1/3, the BS performs resource scheduling for UE 1 over a PDCCH (more specifically, DCI) and UE 1 performs D2D/V2X communication with UE 2 according to the corresponding resource scheduling. After transmitting sidelink control information (SCI) to UE 2 over a physical sidelink control channel (PSCCH), UE 1 may transmit data based on the SCI over a physical sidelink shared channel (PSSCH). Transmission modes 1 and 3 may be applied to D2D and V2X, respectively.

Transmission mode 2/4 may be a mode in which the UE performs autonomous scheduling (self-scheduling). Specifically, transmission mode 2 is applied to D2D. The UE may perform D2D operation by autonomously selecting a resource from a configured resource pool. Transmission mode 4 is applied to V2X. The UE may perform V2X operation by autonomously selecting a resource from a selection window through a sensing process. After transmitting the SCI to UE 2 over the PSCCH, UE 1 may transmit data based on the SCI over the PSSCH. Hereinafter, the term ‘transmission mode’ may be simply referred to as ‘mode’.

Control information transmitted by a BS to a UE over a PDCCH may be referred to as DCI, whereas control information transmitted by a UE to another UE over a PSCCH may be referred to as SCI. The SCI may carry sidelink scheduling information. The SCI may have several formats, for example, SCI format 0 and SCI format 1.

SCI format 0 may be used for scheduling the PSSCH. SCI format 0 may include a frequency hopping flag (1 bit), a resource block allocation and hopping resource allocation field (the number of bits may vary depending on the number of sidelink RBs), a time resource pattern (7 bits), a modulation and coding scheme (MC S) (5 bits), a time advance indication (11 bits), a group destination ID (8 bits), etc.

SCI format 1 may be used for scheduling the PSSCH. SCI format 1 may include a priority (3 bits), a resource reservation (4 bits), the location of frequency resources for initial transmission and retransmission (the number of bits may vary depending on the number of sidelink subchannels), a time gap between initial transmission and retransmission (4 bits), an MCS (5 bits), a retransmission index (1 bit), a reserved information bit, etc. Hereinbelow, the term ‘reserved information bit’ may be simply referred to as ‘reserved bit’. The reserved bit may be added until the bit size of SCI format 1 becomes 32 bits.

SCI format 0 may be used for transmission modes 1 and 2, and SCI format 1 may be used for transmission modes 3 and 4.

Sidelink Resource Pool

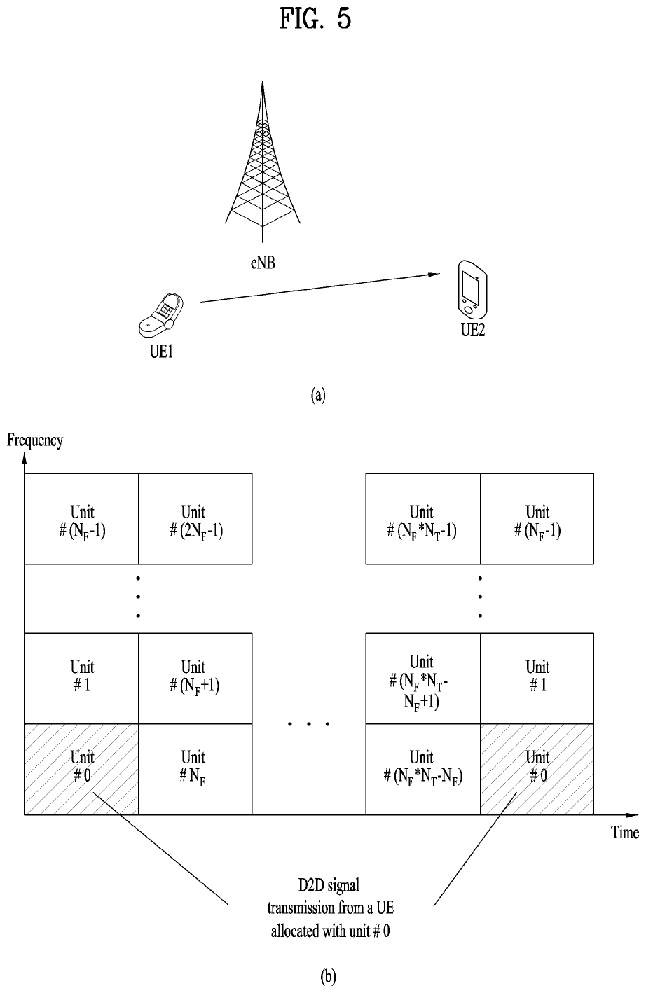

FIG. 5 shows an example of a first UE (UE1), a second UE (UE2) and a resource pool used by UE1 and UE2 performing sidelink communication.

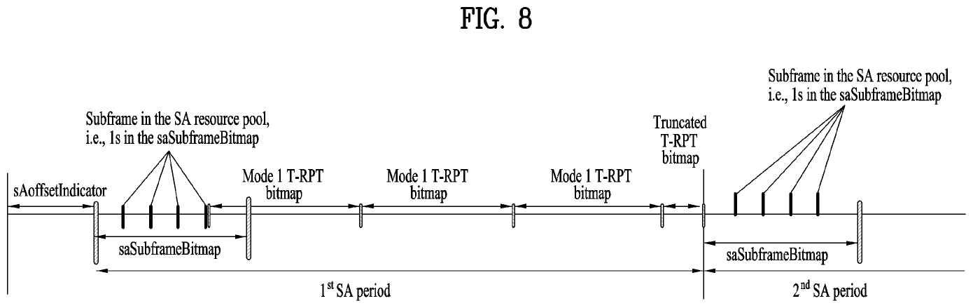

In FIG. 5(a), a UE corresponds to a terminal or such a network device as a BS transmitting and receiving a signal according to a sidelink communication scheme. A UE selects a resource unit corresponding to a specific resource from a resource pool corresponding to a set of resources and the UE transmits a sidelink signal using the selected resource unit. UE2 corresponding to a receiving UE receives a configuration of a resource pool in which UE1 is able to transmit a signal and detects a signal of UE1 in the resource pool. In this case, if UE1 is located in the coverage of a BS, the BS may inform UE1 of the resource pool. If UE1 is located out of the coverage of the BS, the resource pool may be informed by a different UE or may be determined by a predetermined resource. In general, a resource pool includes a plurality of resource units. A UE selects one or more resource units from among a plurality of the resource units and may be able to use the selected resource unit(s) for sidelink signal transmission. FIG. 5(b) shows an example of configuring a resource unit. Referring to FIG. 8(b), the entire frequency resources are divided into the NF number of resource units and the entire time resources are divided into the NT number of resource units. In particular, it is able to define NF*NT number of resource units in total. In particular, a resource pool may be repeated with a period of NT subframes. Specifically, as shown in FIG. 8, one resource unit may periodically and repeatedly appear. Or, an index of a physical resource unit to which a logical resource unit is mapped may change with a predetermined pattern according to time to obtain a diversity gain in time domain and/or frequency domain. In this resource unit structure, a resource pool may correspond to a set of resource units capable of being used by a UE intending to transmit a sidelink signal.

A resource pool may be classified into various types. First of all, the resource pool may be classified according to contents of a sidelink signal transmitted via each resource pool. For example, the contents of the sidelink signal may be classified into various signals and a separate resource pool may be configured according to each of the contents. The contents of the sidelink signal may include a scheduling assignment (SA or physical sidelink control channel (PSCCH)), a sidelink data channel, and a discovery channel. The SA may correspond to a signal including information on a resource position of a sidelink data channel, information on a modulation and coding scheme (MCS) necessary for modulating and demodulating a data channel, information on a MIMO transmission scheme, information on a timing advance (TA), and the like. The SA signal may be transmitted on an identical resource unit in a manner of being multiplexed with sidelink data. In this case, an SA resource pool may correspond to a pool of resources that an SA and sidelink data are transmitted in a manner of being multiplexed. The SA signal may also be referred to as a sidelink control channel or a physical sidelink control channel (PSCCH). The sidelink data channel (or, physical sidelink shared channel (PSSCH)) corresponds to a resource pool used by a transmitting UE to transmit user data. If an SA and a sidelink data are transmitted in a manner of being multiplexed in an identical resource unit, sidelink data channel except SA information may be transmitted only in a resource pool for the sidelink data channel. In other word, REs, which are used to transmit SA information in a specific resource unit of an SA resource pool, may also be used for transmitting sidelink data in a sidelink data channel resource pool. The discovery channel may correspond to a resource pool for a message that enables a neighboring UE to discover transmitting UE transmitting information such as ID of the UE, and the like.

Despite the same contents, sidelink signals may use different resource pools according to the transmission and reception properties of the sidelink signals. For example, despite the same sidelink data channels or the same discovery messages, they may be distinguished by different resource pools according to transmission timing determination schemes for the sidelink signals (e.g., whether a sidelink signal is transmitted at the reception time of a synchronization reference signal or at a time resulting from applying a predetermined TA to the reception time of the synchronization reference signal), resource allocation schemes for the sidelink signals (e.g., whether a BS configures the transmission resources of an individual signal for an individual transmitting UE or the individual transmitting UE autonomously selects the transmission resources of an individual signal in a pool), the signal formats of the sidelink signals (e.g., the number of symbols occupied by each sidelink signal in one subframe or the number of subframes used for transmission of a sidelink signal), signal strengths from the BS, the transmission power of a sidelink UE, and so on. In sidelink communication, a mode in which a BS directly indicates transmission resources to a sidelink transmitting UE is referred to as sidelink transmission mode 1, and a mode in which a transmission resource area is preconfigured or the BS configures a transmission resource area and the UE directly selects transmission resources is referred to as sidelink transmission mode 2. In sidelink discovery, a mode in which a BS directly indicates resources is referred to as Type 2, and a mode in which a UE selects transmission resources directly from a preconfigured resource area or a resource area indicated by the BS is referred to as Type 1.

In V2X, sidelink transmission mode 3 based on centralized scheduling and sidelink transmission mode 4 based on distributed scheduling are available.

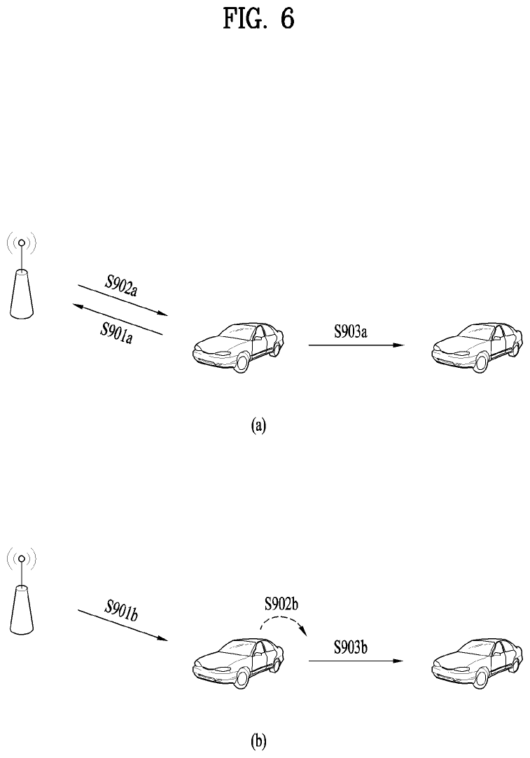

FIG. 6 illustrates scheduling schemes based on these two transmission modes. Referring to FIG. 6, in transmission mode 3 based on centralized scheduling of FIG. 6(a), a vehicle requests sidelink resources to a BS (S901a), and the BS allocates the resources (S902a). Then, the vehicle transmits a signal on the resources to another vehicle (S903a). In the centralized transmission, resources on another carrier may also be scheduled. In transmission mode 4 based on distributed scheduling of FIG. 6(b), a vehicle selects transmission resources (S902b) by sensing a resource pool, which is preconfigured by a BS (S901b). Then, the vehicle may transmit a signal on the selected resources to another vehicle (S903b).

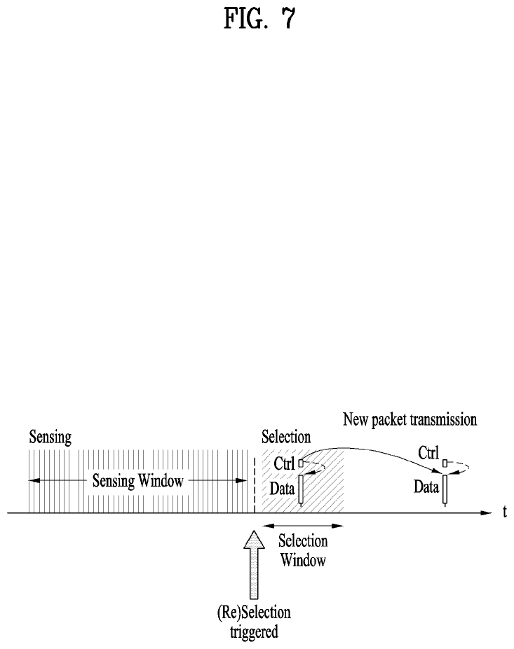

When the transmission resources are selected, transmission resources for a next packet are also reserved as illustrated in FIG. 7. In V2X, transmission is performed twice for each MAC PDU. When resources for initial transmission are selected, resources for retransmission are also reserved with a predetermined time gap from the resources for the initial transmission. The UE may identify transmission resources reserved or used by other UEs through sensing in a sensing window, exclude the transmission resources from a selection window, and randomly select resources with less interference from among the remaining resources.

For example, the UE may decode a PSCCH including information about the cycle of reserved resources within the sensing window and measure PSSCH RSRP on periodic resources determined based on the PSCCH. The UE may exclude resources with PSCCH RSRP more than a threshold from the selection window. Thereafter, the UE may randomly select sidelink resources from the remaining resources in the selection window.

Alternatively, the UE may measure received signal strength indication (RSSI) for the periodic resources in the sensing window and identify resources with less interference, for example, the bottom 20 percent. After selecting resources included in the selection window from among the periodic resources, the UE may randomly select sidelink resources from among the resources included in the selection window. For example, when PSCCH decoding fails, the above method may be applied.

The details thereof may be found in clause 14 of 3GPP TS 3GPP TS 36.213 V14.6.0, which are incorporated herein by reference.

Transmission and Reception of PSCCH

In sidelink transmission mode 1, a UE may transmit a PSCCH (sidelink control signal, SCI, etc.) on a resource configured by a BS. In sidelink transmission mode 2, the BS may configure resources used for sidelink transmission for the UE, and the UE may transmit the PSCCH by selecting a time-frequency resource from among the configured resources.

FIG. 8 shows a PSCCH period defined for sidelink transmission mode 1 or 2.

Referring to FIG. 8, a first PSCCH (or SA) period may start in a time resource unit apart by a predetermined offset from a specific system frame, where the predetermined offset is indicated by higher layer signaling. Each PSCCH period may include a PSCCH resource pool and a time resource unit pool for sidelink data transmission. The PSCCH resource pool may include the first time resource unit in the PSCCH period to the last time resource unit among time resource units indicated as carrying a PSCCH by a time resource unit bitmap. In mode 1, since a time-resource pattern for transmission (T-RPT) or a time-resource pattern (TRP) is applied, the resource pool for sidelink data transmission may include time resource units used for actual transmission. As shown in the drawing, when the number of time resource units included in the PSCCH period except for the PSCCH resource pool is more than the number of T-RPT bits, the T-RPT may be applied repeatedly, and the last applied T-RPT may be truncated as many as the number of remaining time resource units. A transmitting UE performs transmission at a T-RPT position of 1 in a T-RPT bitmap, and transmission is performed four times in one MAC PDU.

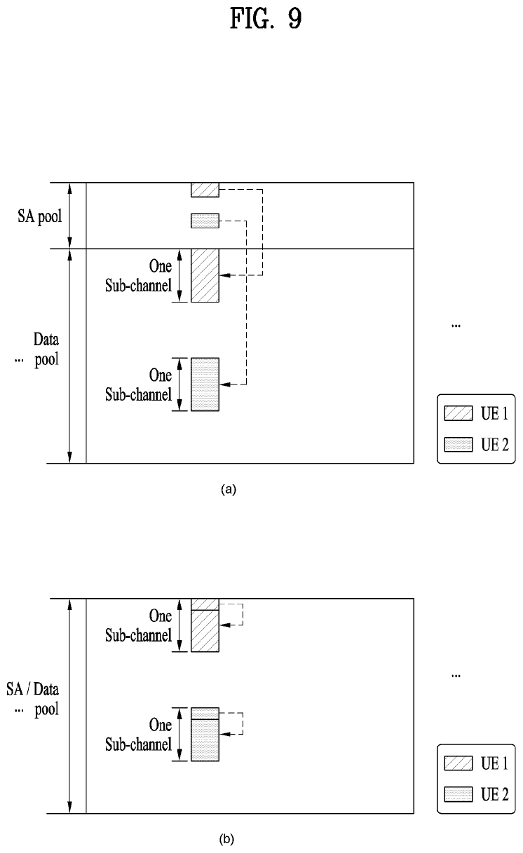

In V2X, that is, sidelink transmission mode 3 or 4, a PSCCH and data (PSSCH) are frequency division multiplexed (FDM) and transmitted, unlike sidelink communication. Since latency reduction is important in V2X in consideration of the nature of vehicle communication, the PSCCH and data are FDM and transmitted on the same time resources but different frequency resources. FIG. 9 illustrates examples of this transmission scheme. The PSCCH and data may not be contiguous to each other as illustrated in FIG. 9(a) or may be contiguous to each other as illustrated in FIG. 9(b). A subchannel is used as the basic unit for the transmission. The subchannel is a resource unit including one or more RBs in the frequency domain within a predetermined time resource (e.g., time resource unit). The number of RBs included in the subchannel, i.e., the size of the subchannel and the starting position of the subchannel in the frequency domain are indicated by higher layer signaling.

For V2V communication, a periodic type of cooperative awareness message (CAM) and an event-triggered type of decentralized environmental notification message (DENM) may be used. The CAM may include dynamic state information of a vehicle such as direction and speed, vehicle static data such as dimensions, and basic vehicle information such as ambient illumination states, path details, etc. The CAM may be 50 to 300 bytes long. In addition, the CAM is broadcast, and its latency should be less than 100 ms. The DENM may be generated upon occurrence of an unexpected incident such as a breakdown, an accident, etc. The DENM may be shorter than 3000 bytes, and it may be received by all vehicles within the transmission range. The DENM may have priority over the CAM. When it is said that messages are prioritized, it may mean that from the perspective of a UE, if there are a plurality of messages to be transmitted at the same time, a message with the highest priority is preferentially transmitted, or among the plurality of messages, the message with highest priority is transmitted earlier in time than other messages. From the perspective of multiple UEs, a high-priority message may be regarded to be less vulnerable to interference than a low-priority message, thereby reducing the probability of reception error. If security overhead is included in the CAM, the CAM may have a large message size compared to when there is no security overhead.

Sidelink Congestion Control

A sidelink radio communication environment may easily become congested according to increases in the density of vehicles, the amount of information transfer, etc. Various methods are applicable for congestion reduction. For example, distributed congestion control may be applied.

In the distributed congestion control, a UE understands the congestion level of a network and performs transmission control. In this case, the congestion control needs to be performed in consideration of the priorities of traffic (e.g., packets).

Specifically, each UE may measure a channel busy ratio (CBR) and then determine the maximum value (CRlimitk) of a channel occupancy ratio (CRk) that can be occupied by each traffic priority (e.g., k) according to the CBR. For example, the UE may calculate the maximum value (CRlimitk) of the channel occupancy ratio for each traffic priority based on CBR measurement values and a predetermined table. If traffic has a higher priority, the maximum value of the channel occupancy ratio may increase.

The UE may perform the congestion control as follows. The UE may limit the sum of the channel occupancy ratios of traffic with a priority k such that the sum does not exceed a predetermined value, where k is less than i. According to this method, the channel occupancy ratios of traffic with low priorities are further restricted.

Furthermore, the UE may use methods such as control of the magnitude of transmission power, packet drop, determination of retransmission or non-retransmission, and control of the size of a transmission RB (MCS adjustment).

5G Use Cases

Three main requirement categories for 5G include (1) a category of enhanced mobile broadband (eMBB), (2) a category of massive machine type communication (mMTC), and (3) a category of ultra-reliable and low-latency communications (URLLC).

Partial use cases may require a plurality of categories for optimization and other use cases may focus upon only one key performance indicator (KPI). 5G supports such various use cases using a flexible and reliable method.

eMBB far surpasses basic mobile Internet access and covers abundant bidirectional work and media and entertainment applications in cloud and augmented reality. Data is one of a core driving force of 5G and, in the 5G era, a dedicated voice service may not be provided for the first time. In 5G, it is expected that voice will simply be processed as an application program using data connection provided by a communication system. Main causes for increased traffic volume are increase in the size of content and an increase in the number of applications requiring high data transmission rate. A streaming service (of audio and video), conversational video, and mobile Internet access will be more widely used as more devices are connected to the Internet. These application programs require always-on connectivity in order to push real-time information and alerts to users. Cloud storage and applications are rapidly increasing in a mobile communication platform and may be applied to both work and entertainment. Cloud storage is a special use case which accelerates growth of uplink data transmission rate. 5G is also used for cloud-based remote work. When a tactile interface is used, 5G demands much lower end-to-end latency to maintain good user experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential IoT devices will reach 20.4 billion up to the year of 2020. Industrial IoT is one of categories of performing a main role enabling a smart city, asset tracking, smart utilities, agriculture, and security infrastructure through 5G.

URLLC includes new services that will transform industries with ultra-reliable/available, low-latency links such as remote control of critical infrastructure and a self-driving vehicle. A level of reliability and latency is essential to control and adjust a smart grid, industrial automation, robotics, and a drone.

Next, a plurality of use cases will be described in more detail.

5G is a means of providing streaming at a few hundred megabits per second to gigabits per second and may complement fiber-to-the-home (FTTH) and cable-based broadband (or DOCSIS). Such high speed is needed to deliver TV at a resolution of 4K or more (6K, 8K, and more), as well as virtual reality and augmented reality. Virtual reality (VR) and augmented reality (AR) applications include immersive sports games. A specific application program may require a special network configuration. For example, for VR games, gaming companies need to incorporate a core server into an edge network server of a network operator in order to minimize latency.

Automotive is expected to be a new important driving force in 5G together with many use cases for mobile communication for vehicles. For example, entertainment for passengers requires high simultaneous capacity and mobile broadband with high mobility. This is because future users continue to expect high connection quality regardless of location and speed. Another automotive use case is an AR dashboard. The AR dashboard displays information talking to a driver about a distance to an object and movement of the object by being superimposed on an object seen from a front window to identify an object in the dark. In the future, a wireless module will enable communication between vehicles, information exchange between a vehicle and supporting infrastructure, and information exchange between a vehicle and other connected devices (e.g., devices transported by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by a human being.

A smart city and a smart home mentioned as a smart society will be embedded in a high-density wireless sensor network. A distributed network of an intelligent sensor will identify conditions for costs and energy-efficient maintenance of a city or a home. Similar configurations may be performed for respective households. All temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is highly decentralized so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of energy such as electricity by a method having efficiency, reliability, economic feasibility, sustainability of production, and automatability. The smart grid may also be regarded as another sensor network having low latency.

A health care part contains many application programs capable of enjoying the benefits of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in an industrial application field. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of cables and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

### EMBODIMENTS

Measuring the UE position can be implemented by measuring latency of signals of a wireless UE (such as a mobile UE), the position of which is pre-recognized as a known value. At this time, when RF signals are processed through multipath fading and are then received, a latency measurement error may occur. In order to measure the UE position, signals from at least three fixed nodes should be transmitted or received. If many fixed nodes do not exist in a peripheral region of the UE, it may be difficult to correctly measure the UE position.

In order to address this issue, the present disclosure provides a method for correctly estimating the UE position using multiple antennas and multipath channels while the UE communicates with one or more fixed nodes.

The present disclosure provides a method for estimating the UE position using multipath fading of RF signals. In detail, a first UE (i.e., a reception (Rx) UE) may measure a multipath delay, a transmission (Tx) incident angle (i.e., AoD), a reception (Rx) incident angle (i.e., AoA) of RF signals received from a second UE (i.e., a transmission (Tx) UE or a base station BS), so that the first UE can precisely measure the position of the second UE.

The present disclosure provides a method for measuring the UE position by measuring an NLOS path and AoA/AoD on the assumption that a first arrival path is set to LOS (Line of Sight). Here, AoA is an abbreviation of Angle of Arrival, and AoD is an abbreviation of Angle of Departure. In addition, Non-Line-Of-Sight (NLOS) may refer to a specific state in which a Tx antenna and an Rx antenna are not placed on a straight line while simultaneously facing each other within a beam width of each antenna, or may refer to a specific state in which a line of sight (LOS) condition that has no obstacle in a propagation path between a transmitter and a receiver in wireless communication is not satisfied.

It is assumed that the first UE can measure a time difference between paths. Also, it is assumed that the first UE can measure AoA and/or AoD of each path.

Case 1) One embodiment of the present disclosure provides a method for measuring the UE position when the first UE can measure both AoA and AoD.

For example, the second UE (e.g., a fixed node such as a base station BS) can transmit a specific reference signal (RS). At this time, the reference signal (RS) can transmit as many RSs for multiple ports as the number of physical antenna ports and/or logical antenna ports. Here, the logical antenna port may refer to the number of RF chains. That is, the logical antenna port may refer to a maximum number of spatial layers that can be processed by the UE within a baseband. In addition, for example, assuming that the number of BS antennas is set to N, a maximum of N different RSs can be transmitted. The respective RSs may be different in time, frequency, and RS sequence from each other.

The first UE (e.g., a mobile UE) can measure AoA and AoD by performing channel estimation using multiple antennas. Here, this measurement method may be implemented as an ultra-high frequency detection algorithm, for example, a two Dimension Multiple Signal Classifier (2D MUSIC) or an Estimation of Signal Parameters via Rotational Invariance Technique (ESPRIT). In this patent document, there is no limitation as to a method for measuring AoA or AoD.

In association with 2D MUSIC, the following description can be made.

In the case of a ULA antenna, only one-dimensional search can be made available irrespective of algorithms, and it is impossible for the search range to deviate from 0˜π [rad]. Therefore, in order to search for two-dimensional (2D) DOA, there is needed an extended algorithm which requires other array antenna arrangements other than a linear antenna such as ULA and can search for 2D DOA. As a representative antenna arrangement for searching for 2D DOA, the use of a rectangular antenna arrangement may be considered. Since the MUSIC algorithm is applicable to any antenna arrangement, the extended 2D MUSIC algorithm which can search for 2D angle of arrival (AoA) can be applied to a rectangular array antenna structure. Power based on an azimuth angle and an elevation angle that are calculated by applying the 2D MUSIC algorithm to the rectangular array antenna can be represented by the following equation 1.

$${P}_{MU} ( {θ}_{i} , {ϕ}_{i} ) = \frac{1}{{a}^{H} ( {θ}_{i} , {ϕ}_{i} ) {E}_{N} {E}_{N}^{H} a ( {θ}_{i} , {ϕ}_{i} )} \qquad [ Equation 1 ]$$

In Equation 1, a direction vector a(θᵢ,ϕᵢ) based on the i-th DOA candidate angle (θᵢ,ϕᵢ) can be calculated using the following equation 2.

a(θᵢ,ϕᵢ)=e^{-j2πf}^{_{c}}^{t}^{_{d}}^{(θ}^{ᵢ}^{,ϕ}^{ᵢ}⁾ [Equation 2])

In Equation 2, f_{c} is a carrier frequency, t_{d} (θᵢ,ϕᵢ) is a relatively latency between each of signals received by antenna elements and a signal received by a reference antenna element. t_{d} (θᵢ,ϕᵢ) d based on the i-th DOA candidate angle (θᵢ,ϕᵢ) can be defined as denoted by the following equation 3.

$${t}_{d} ( {θ}_{i} , {ϕ}_{i} ) = {x}_{k 1} cos ( {θ}_{i} ) cos ( {ϕ}_{i} ) + {y}_{k 1} cos ( {θ}_{i} ) sin ( {ϕ}_{i} ) + {z}_{k 1} sin ( {θ}_{i} ) = cos ( {θ}_{i} ) [ {x}_{k 1} cos ( {ϕ}_{i} ) + {y}_{k 1} sin ( {ϕ}_{i} ) ] + {z}_{k 1} sin ( {θ}_{i} ) \qquad [ Equation 3 ]$$

In Equation 3, (xₖ₁, yₖ₁, zₖ₁) is a relative position between the k-th antenna and the reference antenna, where k=2, . . . , L. DOA of signals can be estimated using a power) spectrum that is calculated by substituting a(θᵢ,ϕᵢ) shown in Equations 2 and 3 into Equation 1. At this time, (θᵢ,ϕᵢ) and a DOA candidate angle can be determined based on search resolution.

In addition, in association with ESPRIT, the following description can be made available.

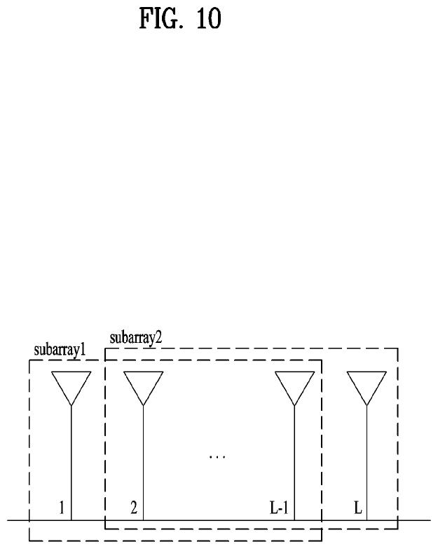

The ESPRIT algorithm is a method for performing AoA (Angle of Arrival) estimation using the property in which antennas spaced apart from each other at intervals of a predetermined distance have the same eigenvalue. That is, Rx signals are processed by dividing one array into two partial arrays as shown in FIG. 10. The output of such partial arrays can be represented by the following equation 4

y₁=A₁s+w₁

y₂=A₂s+w₂[Equation 4]

In Equation 4, a spacing linear array is used so that the antennas are spaced apart from each other by the same distance. A partial array 1 and a partial array 2 may be arranged to have only a phase delay as much as the antenna spacing. Therefore, the direction matrix A1 of the partial array 1 and the direction matrix A2 of the partial array 2 may have the following relationship.

A₂=A₁Φ [Equation 5]

In Equation 5, Φ is set to Φ=diag{e^{jϕ}^{₁}, e^{jϕ}^{₁}, . . . , e^{jϕ}^{_{M}}}, and each of A1 and A2 is an (L−1)×Mₘₐₜᵣᵢₓ.

The direction matrix of each partial array can be represented by a unit matrix using a M×M nonsingular matrix (T).

U₁=A₁T

U₂=A₂T [Equation 6]

In Equation 6, each of U₁ and U₂ is a (L−1)×M matrix in which an eigenvector of the signal received in each partial array is used as a column vector.

The following relationship denoted by Equation 7 can be obtained based on Equations 4 to 6.

U₂=U₁Ψ

Ψ=T⁻¹ΦT [Equation 7]

In Equation 7, since Ψ and Φ have the same eigenvalue, calculating the eigenvalue of Ψ may be used instead of calculating the value of Φ, such that the angle of arrival (AoA) of a received signal can be calculated.

From covariance matrices of two partial array Rx signals shown in Equations 4 and 5, U₁ and U₂ shown in Equations 5 and 6 can be calculated, and the eigenvalue of Ψ can be calculated from the relationship shown in Equation 7. In order to calculate the eigenvalue of Ψ, a least squares method or a total least squares method may be used. In case of using the least squares method, the eigenvalue of Ψ can be calculated as shown in Equation 8.

\hat{Ψ}_{LS}=(U₁^{H}U₁)⁻¹U₁^{H}U₂ [Equation 8]

From the estimated value Ψ, an eigenvalue of zₘ can be calculated as represented by zₘ=e^{jϕ}^{ₘ}, and the angle of arrival (AoA) θₘ can be calculated from the relationship ϕₘ=−2π(d/λ)cos θₘ as denoted by the following equation 9.

$${\hat{θ}}_{m} = arccos \{ \frac{λ}{2 π d} arg ( {z}_{m} ) \} , m = 1 , … , M \qquad [ Equation 9 ]$$

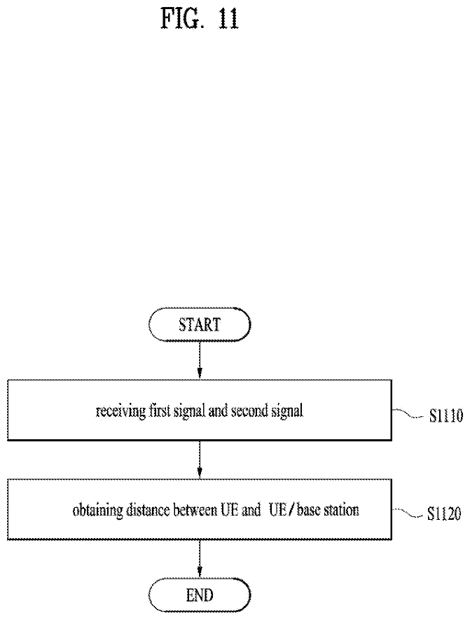

FIG. 11 is a conceptual diagram illustrating the method according to the present disclosure.

Referring to FIG. 11, according to the embodiment of the present disclosure, the method for measuring the distance between the first UE and the second UE or the distance between the first UE and the base station (BS), and measuring the position of the second UE and the position of the BS by the first UE in a wireless communication system may include receiving (S1110), by the UE, a first signal and a second signal from the BS; and measuring, by the UE, the distance between the BS and the UE based on the first signal and the second signal. Here, the distance may be measured based on a first Tx angle, a second Tx angle, a first Rx angle, a second Rx angle, a first Rx time point where the UE receives the first signal, and a second Tx time point where the UE receives the second signal.

Assuming that the first signal or the second signal is transmitted along the NLOS (none line of sight) path, the first Tx angle may refer to an angle between a first reference axis and a path along which the BS transmits the first signal, and the second Tx angle may refer to an angle between the first reference axis and a path along which the BS transmits the second signal. The first Rx angle may refer to an angle between a second reference axis and a path along which the UE receives the first signal, and the second Rx angle may refer to an angle between the second reference axis and a path along which the UE receives the second signal.

Whether or not the first signal or the second signal is transmitted along the LOS path can be determined based on phase distribution of channel components related to PRS (positioning reference signal). On the other hand, the UE may determine that the first signal or the second signal is transmitted along the NLOS path, and the distance between the BS and the UE may be measured by the UE based on a predetermined offset value.

Further, the method according to the embodiment of the present disclosure may further include receiving, by the UE, information indicating the first reference axis and the second reference axis from the BS.

In addition, the method may further include transmitting, by the UE, information indicating the first reference axis or the second reference axis to the BS.

When the UE does not acquire the first Tx angle or the second Tx angle, the method may further include transmitting, by the UE, a feedback signal including information about the first Rx angle and information about the second Rx angle to the BS. In this case, the distance between the BS and the UE can be measured by the BS.

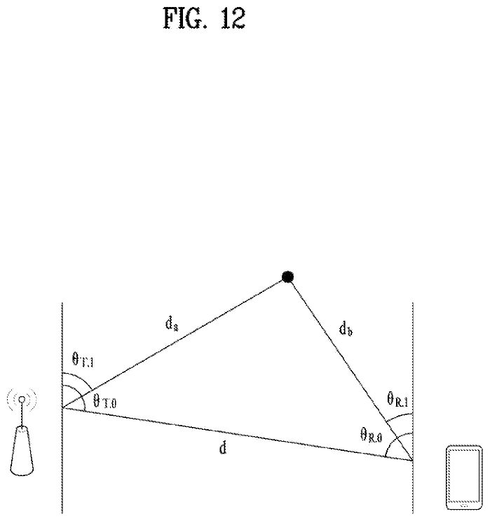

Still referring to FIG. 12, the distance (d) between the BS and the UE can be acquired, calculated, measured, and/or computed using the following equation 10.

$$d = \frac{c \cdot {t}_{0 , 1}}{\frac{sin ( {θ}_{T , 0} - {θ}_{T , 1} ) + sin ( {θ}_{R , 0} - {θ}_{R , 1} )}{sin ( π - ( {θ}_{T , 0} - {θ}_{T , 1} + {θ}_{R , 0} - {θ}_{R , 1} )} - 1} \qquad [ Equation 10 ]$$

In Equation 10, c is the speed of light, t_{0,1} is a time difference between the first Rx time and the second Rx time, θ_{T,0} is the first Tx angle, θ_{T,1} is the second Tx angle, θ_{R,0} is the first Rx angle, and θ_{R,1} is the second Rx angle.

In one embodiment, it is assumed that the first UE can measure a time difference between paths of channels and can also measure AoA and AoD for each path.

In FIG. 12, θ_{T,i} is AoD of the i-th path, θ_{R,i} is AoA of the i-th path, and it is assumed that LOS (Line of Sight) is made at ‘i=0’.

By AoA and AoD measurement, the first UE can draw a triangular shape as shown in FIG. 12. One embodiment of the present disclosure can propose the following equation 11 using the triangular Sine law.

$$\frac{sin ( π - ( {θ}_{T , 0} - {θ}_{T , 1} + {θ}_{R , 0} - {θ}_{R , 1} )}{d} = \frac{sin ( {θ}_{T , 0} - {θ}_{T , 1} )}{{d}_{b}} = \frac{sin ( {θ}_{R , 0} - {θ}_{R , 1} )}{{d}_{a}} \qquad [ Equation 11 ]$$

In addition, the following equation 12 can be acquired using Equation 11.

$${d}_{a} = \frac{d \cdot sin ( {θ}_{R , 0} - {θ}_{R , 1} )}{sin ( π - ( {θ}_{T , 0} - {θ}_{T , 1} + {θ}_{R , 0} - {θ}_{R , 1} ) )} \\ {d}_{b} = \frac{d \cdot sin ( {θ}_{T , 0} - {θ}_{T , 1} )}{sin ( π - ( {θ}_{T , 0} - {θ}_{T , 1} + {θ}_{R , 0} - {θ}_{R , 1} ) )} \qquad [ Equation 12 ]$$

In Equation 12, the first UE can measure a time difference t_{0,1} between a first path and a second path. Here, t_{0,1} is a time difference between the first path and the second path. The following equation 13 can be acquired based on a distance difference between the respective paths.

−c·t_{0,1}=d−(d_{α}+d_{c}) [Equation 13]

In Equation 13, c is the speed of light and is about 2.99×10\hat{ }8 [m/sec]. The distance (d) can be calculated using the following equation 14 based on Equation 13.

$$d = \frac{c \cdot {t}_{0 , 1}}{\frac{sin ( {θ}_{T , 0} - {θ}_{T , 1} ) + sin ( {θ}_{R , 0} - {θ}_{R , 1} )}{sin ( π - ( {θ}_{T , 0} - {θ}_{T , 1} + {θ}_{R , 0} - {θ}_{R , 1} ) )} - 1} \qquad [ Equation 14 ]$$

Since the Rx UE has measured AoA and AoD of the LOS path, the Rx UE can measure its own position using the position of the second UE.

In this patent document, although the embodiments have been disclosed using a 2D (2D plane) angle and the UE position (e.g., X and Y coordinates) for convenience of description, if the UE aims to measure a 3D (3D plane) position, the scope of the embodiments can be extended to addition of parameters related to an angle from a zenith and a height from the zenith (e.g., Z-axis coordinates). In order to perform three-dimensional (3D) UE positioning, the number of unknown numbers increases, so that as many unknown numbers as the number of increased unknown numbers can be added to the following description.

In addition, when each of the transmitter and the receiver measures the angle, it is assumed that reference angles (e.g., an orientation angle, a reference angle, etc.) of the transmitter and the receiver are identical to each other. If the reference angles are not identical to each other, a process or algorithm for measuring the orientation angle can be introduced.

For example, a fixed node (e.g., a BS such as eNB or gNB, a relay, and an AN) can signal information about its own orientation angle to the UE through a physical layer signal or a higher layer signal.

Each of the UE and the fixed node can designate a specific direction as an orientation angle using a magnetic field sensor. To this end, i) the designated orientation angle may be predetermined between the UE and the fixed node, ii) the designated orientation angle may be signaled to the UE through physical layer signaling or higher layer signaling of the fixed node, or iii) the UE may signal information about its own orientation angle to the fixed node through physical layer signaling or higher layer signaling (e.g., RRC signaling).

Whereas the orientation angle is considered important in a horizontal direction, the orientation angle should also be determined in a vertical direction. To this end, information about the vertical orientation angle can be signaled between the fixed node and the UE through physical layer signaling or higher layer signaling (e.g., RRC signaling). Alternatively, a UE-decided orientation angle may be measured by a separate sensor (e.g., an inclinometer or a gyroscope sensor) separately provided in the UE. The UE-decided orientation angle may be signaled from the UE to the fixed node through physical layer signaling or higher layer signaling.

In the above-mentioned description, the first signal may be transmitted along the NLOS path, and the second signal may be transmitted along the LOS path. That is, as shown in FIG. 12, it is assumed that signals are transmitted through one LOS path and the other NLOS path for convenience of description. Here, the NLOS (non-line-of-sight) may refer to a specific state in which the Tx antenna and the Rx antenna are not placed on a straight line while simultaneously facing each other within a beam width of each antenna, or may refer to a specific state in which a line of sight (LOS) condition that has no obstacle on a propagation path between a transmitter and a receiver in wireless communication is not satisfied. At this time, it is assumed that a time difference between Rx time points of the respective paths can be measured by the first UE. Since a correct clock state is not maintained between the transmitter and the receiver, the first UE is unable to directly recognize the distance (d) of the LOS path. In the present disclosure, assuming that a single bounce scatter is used, it is assumed that a second path is received after being reflected once from another object.

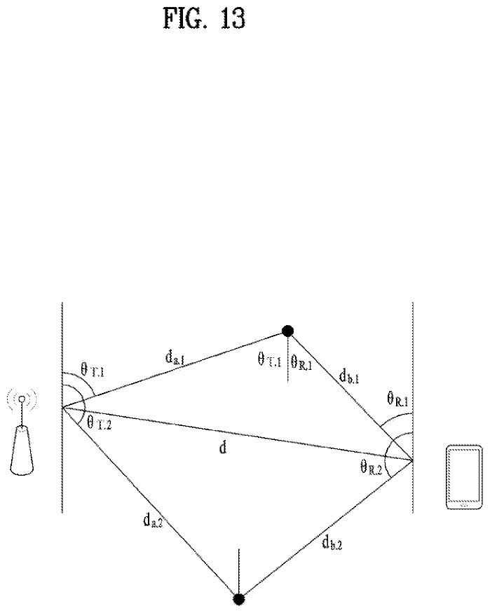

As shown in FIG. 13, when the first signal and the second signal are transmitted along the NLOS path (also, when the first UE is unable to recognize the second signal transmitted along the LOS path), the following equation 15 can be obtained using a distance difference between the first path and the second path. Here, it is assumed that AoA and AoD are measured on the NLOS path and a difference in Rx time between paths are measured on the NLOS path.

d_{a,1}+d_{b,1}−(d_{a,2}+d_{b,2})=−c·t_{1,2} [Equation 15]

In Equation 15, the Sine law may be used by referring to the distance of the LOS path and the AoA/AoD parameters, so that the following equation 16 can be obtained.

$$\frac{sin ( {θ}_{T , 1} + {θ}_{R , 1} )}{d} = \frac{sin ( {θ}_{R , 0} - {θ}_{R , 1} )}{{d}_{a , 1}} = \frac{sin ( {θ}_{T , 0} - {θ}_{T , 1} )}{{d}_{b , 1}} \qquad [ Equation 16 ]$$

In Equation 16, d_{a,1} and d_{b,1} can be denoted by functions of AoA/AoD of the distance (d) and the LOS path (See Equation 17 below).

$${d}_{a , 1} = {f}_{1} ( d , {θ}_{R , 0} ) = \frac{d \cdot sin ( {θ}_{R , 0} - {θ}_{R , 1} )}{sin ( {θ}_{T , 1} + {θ}_{R , 1} )} \\ {d}_{b , 1} = {g}_{1} ( d , {θ}_{T , 0} ) = \frac{d \cdot sin ( {θ}_{T , 0} - {θ}_{T , 1} )}{sin ( {θ}_{T , 1} - {θ}_{R , 1} )} \qquad [ Equation 17 ]$$

Similarly, d_{a,2} and d_{b,2} can be denoted by functions of AoA/AoD of the distance (d) and the LOS path (See Equation 18 below).

$${d}_{a , 2} = {f}_{2} ( d , {θ}_{R , 0} ) = \frac{d \cdot sin ( {θ}_{R , 0} - {θ}_{R , 2} )}{sin ( {θ}_{T , 2} + {θ}_{R , 2} )} \\ {d}_{b , 2} = {g}_{2} ( d , {θ}_{T , 0} ) = \frac{d \cdot sin ( {θ}_{R , 0} - {θ}_{R , 2} )}{sin ( {θ}_{T , 2} - {θ}_{R , 2} )} \qquad [ Equation 18 ]$$

By means of the above equations, the following equation can be rewritten as a function of d, θ_{R,0}, θ_{T,0} (See Equation 19 below).

f₁(d,θ_{R,0})+g₁(d,θ_{T,0})−f₂(d,θ_{R,0})+g₂(d,θ_{T,0}))=−c·t_{1,2} [Equation 19]

Equation 19 is an equation having three unknown numbers. In order to solve the above equation having three unknown numbers, more equations are required. For example, assuming that the number of paths is set to 3, a total of three equations can be made, so that the problem can be solved. That is, if the LOS path is considered invisible, the problem can be solved in a modified manner.

Therefore, when the first signal and the second signal are transmitted on the NLOS path, the first UE may consider that the second signal is transmitted along the LOS path. At this time, a predetermined offset value can be applied to the distance (d). Here, the offset value may be differently determined depending on the AoA or AoD value. For example, according to a statistical measurement result, it is assumed that the offset values based on the AoA and/or AoD values are predetermined, so that the UE can perform application of the resultant offset based on the AoA/AoD measurement results thereof. In other words, it is assumed that the first path is always at a line of sight (LOS) condition, the distance (d) is calculated, and the offset is applied according to the AoA and/or AoD measurement values, so that the distance (d) can be estimated and corrected. For this operation, the UE can feed back the AoA and/or AoD values, Rx power of each path, information about whether each path is at LOS (line-of-sight) or NLOS (none-line-of-sight), and/or information about the UE position based on GPS or other technologies to the network through physical layer signaling or higher layer signaling. The network can construct information about a difference between a UE-measured distance value and the actual distance value in a database (DB) format, can determine an offset value by referring to the constructed DB information, and can signal the determined value to neighboring UEs through physical layer signaling or higher layer signaling. Here, the UE-measured distance value may be measured by the UE that is designed to use multiple paths based on AoA and AoD values and other measurement values that are fed back from a plurality of UEs. The Rx UE may pre-recognize θ_{R,1} θ_{R,2} θ_{T,1} θ_{T,2} as known values. In addition, θ_{T,0}, θ_{R,0} may be received through signaling, or may be calculated based on a signal (e.g., LOS signal) (pre-)exchanged between the Tx UE and the Rx UE. If the Rx UE has pre-recognized the position of the Tx UE, θ_{T,0}, θ_{R,0} can be calculated through a virtual LOS path (and/or θ_{R,1} θ_{R,2} θ_{T,1} θ_{T,2} information).

Therefore, the above-mentioned method of FIG. 12 may further include receiving, by the UE, a third signal from the BS. Here, the distance between the BS and the UE may be measured not only based on a third Tx angle, a third Rx angle, and a time difference between the first Tx time point and a third Rx time point where the UE receives the third signal, but also based on a time difference between the third Rx time point and the second Rx time point. Whether the first signal or the second signal is transmitted on the LOS path can be determined through phase distribution of channel components related to PRS (positioning reference signal). Here, the third signal may be an LOS signal.

The first UE may use different positioning methods according to whether the LOS path is visible or invisible.

The presence or absence of the LOS path can be determined by the first UE through phase distribution of channel components applied to the reference signal (RS) (e.g., PRS or a reference signal (RS) for UE positioning). For example, it is expected that, in the LOS channel, phase distribution indicates that phases are linearly changed, it is expected that, in the NLOS channel, phase distribution indicates that phases are non-linearly changed, and it is also expected that variance is large. Alternatively, the presence or absence of LOS/NLOS paths can also be determined based on Rx power of each path and a path loss of each path.

If the LOS path is visible or invisible, the above proposed method can be used.

If the LOS path is invisible, UE positioning can be performed on the assumption that the first path of the NLOS path is set to the LOS path. In this case, since it is expected that an unexpected error will occur in the UE positioning process, an offset value is applied to a position value estimated by the first UE, and the final position value is then determined based on the offset value.

One embodiment of the present disclosure provides a method for measuring the UE position when the first UE can measure only the AoA (Angle of Arrival).

Since only the angle of the signal reception (Rx) direction can be measured by one UE within one direction, it may be necessary for the other UE facing the one UE to feed back the AoA parameter measured by the other UE itself. However, during transmission of the feedback signal, two-way ranging can be performed, so that it is possible to directly estimate the distance (d). Through such two-way ranging, the feedback signal can be transmitted based on signals transmitted by the transmitter, so that the transmitter can measure the distance between the transmitter and the receiver using the feedback signal. As a result, in this case, the multi-path channel can be used to correct the ranging result.

Alternatively, Tx power as much as power required for two-way ranging is not guaranteed, or it may be necessary for signals to be transmitted to other cells, so that Tx power of the UE can be excessively used. As a result, the first UE may feed back only the AoA measured by the first UE itself as necessary. In case of “without two-way ranging”, the first UE may feed back the AoA value of each path to the counterpart UE (or network) through physical layer signaling or higher layer signaling.

The UE can feed back the measured AoA (and/or AoD) values for each path to the transmitter. In this case, instead of feeding back the AoA (and/or AoD) values of all paths, the UE may feed back an AoA (and/or AoD) value for either a path (where Rx power is equal to or greater than a predefined threshold) or a specific path. This is because a path having a very small amount of Rx power is not helpful to perform positioning of the actual UE.

In addition, the UE can feed back information about a time difference between paths to the fixed node.

Although the inventive aspects and/or embodiment(s) of the present disclosure can be regarded as one proposed method, it should be noted that a combination thereof can also be considered to be a new method. In addition, it should also be understood that the inventive aspects are not limited to the embodiments and also are not limited to a specific system and can be applied to other systems. In case of using all of the parameters and/or operations of the embodiment(s), a combination of the parameters and operations, information about whether or not the corresponding parameter and/or operation is applied, and/or a combination of the parameters and/or operations, the BS may pre-configure information through higher layer signaling to the UE and/or physical layer signaling to the UE, or may define such information in the system in advance. In addition, each aspect of the embodiment(s) may be defined as one operation mode, and one of the operation modes may be pre-configured through higher layer signaling and/or physical layer signaling between the BS and the UE, so that the BS can operate in the corresponding operation mode. The transmission time interval (TTI) of the embodiment(s) or a resource unit for signal transmission may correspond to various lengths of units, such as a sub-slot/slot/subframe or a basic unit for signal transmission. The UE described in the embodiment(s) may correspond to various types of devices such as a vehicle, a pedestrian UE, and the like. In addition, operations of the UE, BS, and/or RSU (road side unit) described in the embodiment(s) are not limited to a specific type of devices, and can also be applied to different types of devices. For example, in the embodiment(s), the details written in base station (BS) operations can be applied to UE operations. Alternatively, among the details of the embodiment(s), some content applicable to direct UE-to-UE communication can also be applied to communication between the UE and the BS (e.g., uplink or downlink communication). At this time, the proposed method can be used for communication between the UE and the BS (or a relay node), communication between the UE and a specific type of UE such as a UE-type RSU, and/or communication between specific types of wireless devices. In the above description, the term “base station BS” can also be replaced with relay node, UE-type RSU, etc. as necessary.

Example of Communication System to which the Present Disclosure is Applied

Various descriptions, functions, procedures, proposals, methods and/or operational flowcharts of the present disclosure disclosed in this document are applicable, but limited, to various fields requiring wireless communication/connection (e.g., 5G) between devices.

Hereinafter, examples will be illustrated in more detail with reference to the drawings. In the following drawings/description, the same reference numerals may exemplify the same or corresponding hardware blocks, software blocks, or functional blocks, unless otherwise indicated.

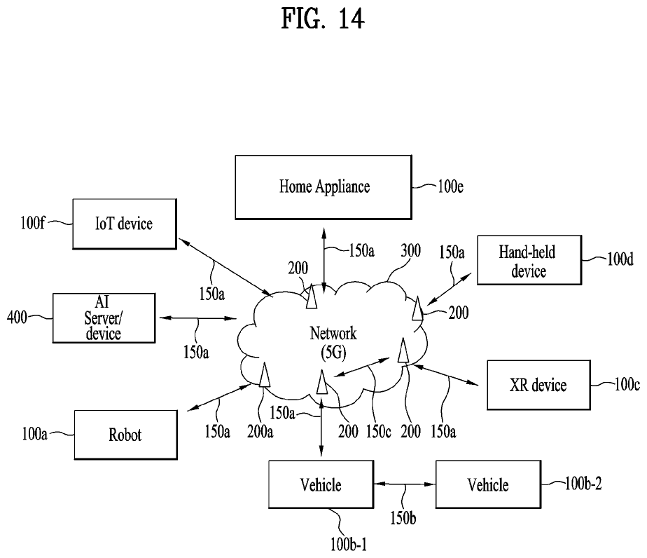

FIG. 14 illustrates a communication system 1 applied to the present disclosure.

Referring to FIG. 14, a communication system 1 applied to the present disclosure includes wireless devices, BSs, and a network. Herein, the wireless devices represent devices performing communication using RAT (e.g., 5G NR or LTE) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of things (IoT) device 100f, and an artificial intelligence (AI) device/server 400. For example, the vehicles may include a vehicle having a wireless communication function, an autonomous driving vehicle, and a vehicle capable of performing communication between vehicles. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. V2V/V2X communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as UL/DL communication 150a, sidelink communication 150b (or, D2D communication), or inter BS communication (e.g. relay, integrated access backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices Applicable to the Present Disclosure

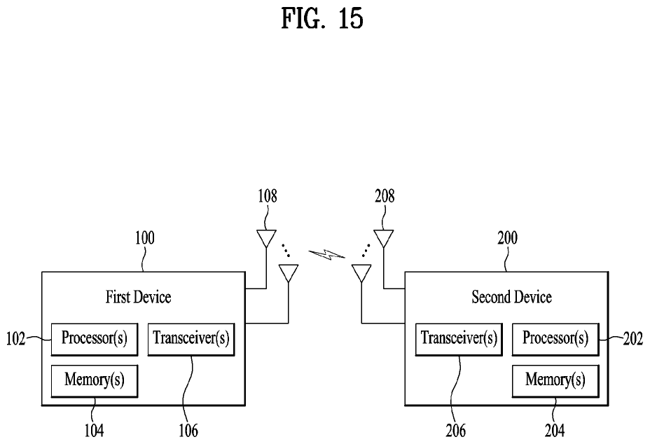

FIG. 15 illustrates wireless devices applicable to the present disclosure.

Referring to FIG. 15, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 14.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor 102 may be configured to implement at least one operation of the above-mentioned methods related to FIG. 11. For example, the processor 102 may control the transceiver 106 to receive a first signal and a second signal from the second wireless device 200, and may measure the distance between the second wireless device 200 and the first wireless device 100 based on the first signal and the second signal. In addition, the distance may be measured based on a first Tx angle, a second Tx angle, a first Rx angle, a second Rx angle, and a time difference between a first Rx time point where the first wireless device 100 receives the first signal and a second Rx time point where the first wireless device 100 receives the second signal.

The processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more service data unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Signal Processing Circuit to which the Present Disclosure is Applicable

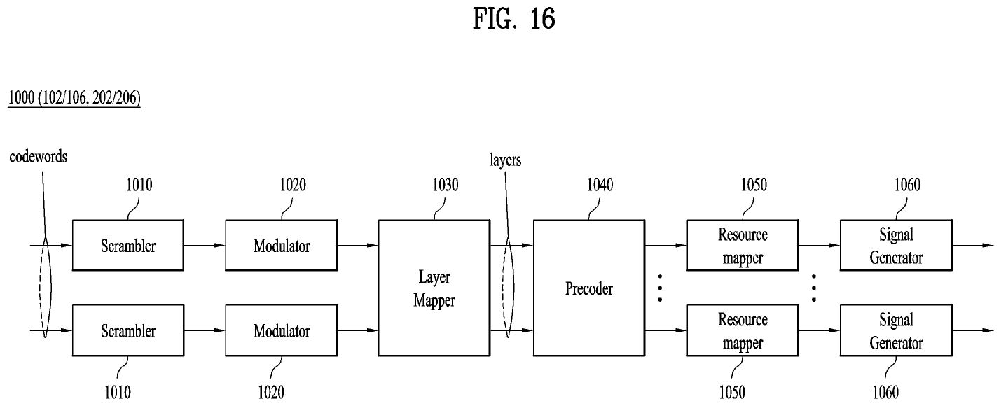

FIG. 16 illustrates a signal process circuit for a transmission signal.

Referring to FIG. 16, a signal processing circuit 1000 may include scramblers 1010, modulators 1020, a layer mapper 1030, a precoder 1040, resource mappers 1050, and signal generators 1060. An operation/function of FIG. 16 may be performed, without being limited to, the processors 102 and 202 and/or the transceivers 106 and 206 of FIG. 15. Hardware elements of FIG. 16 may be implemented by the processors 102 and 202 and/or the transceivers 106 and 206 of FIG. 15. For example, blocks 1010 to 1060 may be implemented by the processors 102 and 202 of FIG. 15. Alternatively, the blocks 1010 to 1050 may be implemented by the processors 102 and 202 of FIG. 15 and the block 1060 may be implemented by the transceivers 106 and 206 of FIG. 15.

Codewords may be converted into radio signals via the signal processing circuit 1000 of FIG. 16. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include IFFT modules, CP inserters, digital-to-analog converters (DACs), and frequency up-converters.

Signal processing procedures for a signal received in the wireless device may be configured in a reverse manner of the signal processing procedures 1010 to 1060 of FIG. 16. For example, the wireless devices (e.g., 100 and 200 of FIG. 15) may receive radio signals from the exterior through the antenna ports/transceivers. The received radio signals may be converted into baseband signals through signal restorers. To this end, the signal restorers may include frequency DL converters, analog-to-digital converters (ADCs), CP remover, and FFT modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

Use Cases of Wireless Devices to which the Present Disclosure is Applied

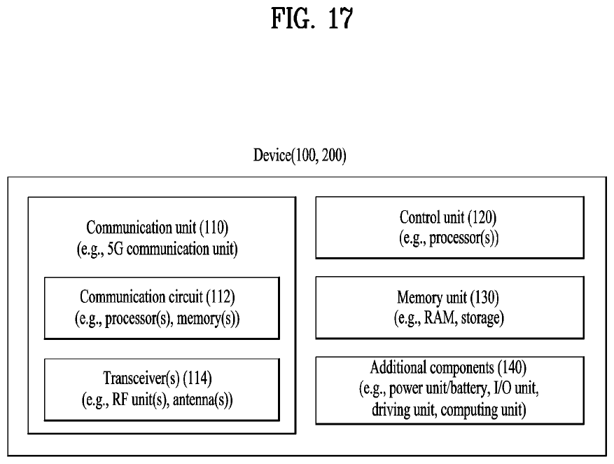

FIG. 17 is a block diagram illustrating a wireless device to which another embodiment of the present disclosure can be applied. The wireless device may be implemented in various forms according to a use case/service (refer to FIGS. 14, 18, 19 and 20).

Referring to FIG. 17, wireless devices 100 and 200 may correspond to the wireless devices 100 and 200 of FIG. 15 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 15. For example, the transceiver(s) 114 may include the one or more transceivers 106 and 206 and/or the one or more antennas 108 and 208 of FIG. 15. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110. For example, the control unit 120 may control electrical and mechanical operations of the wireless device based on program/code/command/information stored in the memory unit 130. In addition, the control unit 120 may transmit information stored in the memory unit 130 to any external device (e.g., another communication device) through the communication unit 110 over a wired/wireless interface, or may store information, that has been received from the external device (e.g., another communication device) through the communication unit 110 over the wired/wireless interface, in the memory unit 130. For example, the control unit 120 may be configured to implement at least one of operations of the above-mentioned methods related to FIG. 11. For example, the control unit 120 may control the communication unit 110 to receive the first signal and the second signal from the wireless device 200, and may measure the distance between the wireless devices 200 and 100 based on the first signal and the second signal. In addition, the distance may be measured based on a first Tx angle, a second Tx angle, a first Rx angle, a second Rx angle, and a time difference between a first Rx time point where the wireless device 100 receives the first signal and a second Rx time point where the wireless device 100 receives the second signal.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 14), the vehicles (100b-1 and 100b-2 of FIG. 14), the XR device (100c of FIG. 14), the hand-held device (100d of FIG. 14), the home appliance (100e of FIG. 14), the IoT device (100f of FIG. 14), a digital broadcast terminal, a hologram device, a public safety device, an MTC device, a medicine device, a FinTech device (or a finance device), a security device, a climate/environment device, the AI server/device (400 of FIG. 14), the BSs (200 of FIG. 14), a network node, etc. The wireless device may be used in a mobile or fixed place according to a use-example/service.

In FIG. 17, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

Hereinafter, an example of implementing FIG. 17 will be described in detail with reference to the drawings.

Examples of a Hand-Held Device Applicable to the Present Disclosure

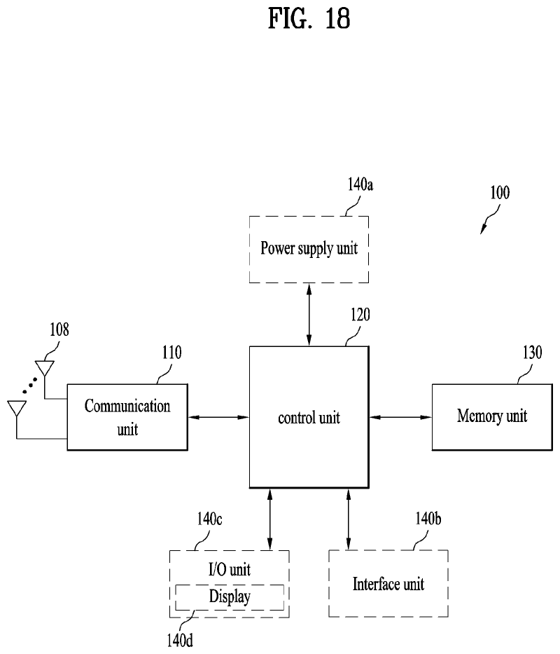

FIG. 18 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a mobile subscriber station (MSS), a subscriber station (SS), an advanced mobile station (AMS), or a wireless terminal (WT).

Referring to FIG. 18, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 17, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an application processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Examples of a Vehicle or an Autonomous Driving Vehicle Applicable to the Present Disclosure

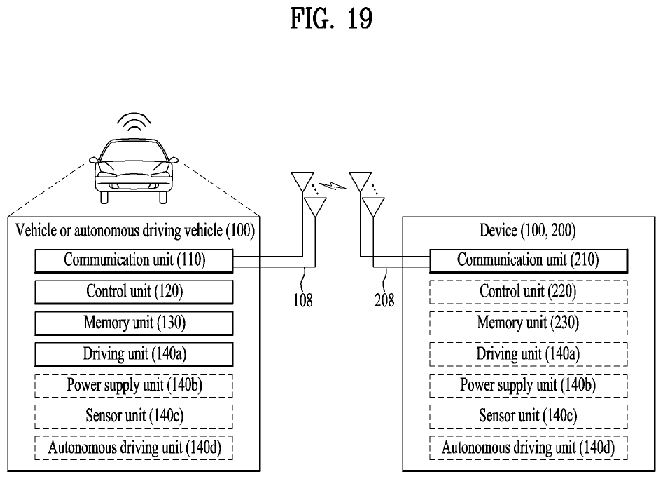

FIG. 19 illustrates a vehicle or an autonomous driving vehicle applied to the present disclosure. The vehicle or autonomous driving vehicle may be implemented by a mobile robot, a car, a train, a manned/unmanned aerial vehicle (AV), a ship, etc.

Referring to FIG. 19, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 17, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. For example, the control unit 120 may be configured to implement at least one of operations of the above-mentioned methods related to FIG. 11. For example, the control unit 120 may control the communication unit 110 to receive a first signal and a second signal from the device 200, and may measure the distance between the device 200 and the vehicle or autonomous driving vehicle 100 based on the first signal and the second signal. In addition, the distance may be measured based on a first Tx angle, a second Tx angle, a first Rx angle, a second Rx angle, and a time difference between a first Rx time point where the vehicle or autonomous driving vehicle 100 receives the first signal, and a second Rx time point where the vehicle or autonomous driving vehicle 100 receives the second signal.

The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Examples of a Vehicle and AR/VR Applicable to the Present Disclosure

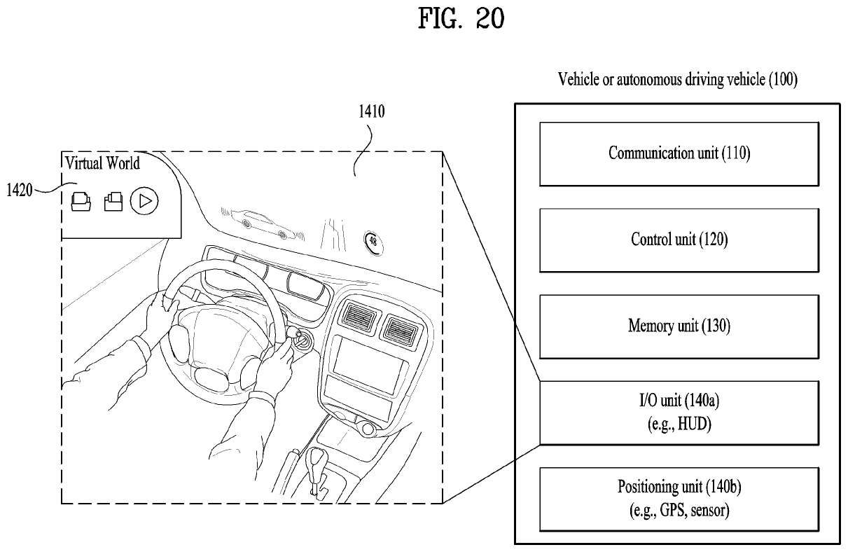

FIG. 20 illustrates a vehicle applied to the present disclosure. The vehicle may be implemented as a transport means, an aerial vehicle, a ship, etc.

Referring to FIG. 20, a vehicle 100 may include a communication unit 110, a control unit 120, a memory unit 130, an I/O unit 140a, and a positioning unit 140b. Herein, the blocks 110 to 130/140a and 140b correspond to blocks 110 to 130/140 of FIG. 17.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410 and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

The above-described embodiments correspond to combinations of elements and features of the present disclosure in prescribed forms. And, the respective elements or features may be considered as selective unless they are explicitly mentioned. Each of the elements or features can be implemented in a form failing to be combined with other elements or features. Moreover, it is able to implement an embodiment of the present disclosure by combining elements and/or features together in part. A sequence of operations explained for each embodiment of the present disclosure can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

In this document, embodiments of the present disclosure have been described mainly based on a signal transmission/reception relationship between a terminal and a base station. Such a transmission/reception relationship is applied to signal transmission/reception between a terminal and a relay or between a base station and a relay in in the same/similar manner. In some cases, a specific operation described in this document as being performed by the base station may be performed by an upper node thereof. That is, it is apparent that various operations performed for communication with a terminal in a network including a plurality of network nodes including a base station may be performed by the base station or network nodes other than the base station. The base station may be replaced with terms such as fixed station, Node B, eNode B (eNB), gNode B (gNB), access point, or the like. In addition, the terminal may be replaced with terms such as User Equipment (UE), Mobile Station (MS), Mobile Subscriber Station (MSS), or the like.

The examples of the present disclosure may be implemented through various means. For example, the examples may be implemented by hardware, firmware, software, or a combination thereof. When implemented by hardware, an example of the present disclosure may be implemented by one or more application specific integrated circuits (ASICs), one or more digital signal processors (DSPs), one or more digital signal processing devices (DSPDs), one or more programmable logic devices (PLDs), one or more field programmable gate arrays (FPGAs), one or more processors, one or more controllers, one or more microcontrollers, one or more microprocessor, or the like.

When implemented by firmware or software, an example of the present disclosure may be implemented in the form of a module, a procedure, or a function that performs the functions or operations described above. Software code may be stored in a memory unit and executed by a processor. The memory unit may be located inside or outside the processor, and may exchange data with the processor by various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The above-mentioned embodiments of the present disclosure are applicable to various mobile communication systems.

What is claimed is:

1. A method for measuring a distance between a first user equipment (UE) and a second user equipment (UE) as well as a position of the second user equipment (UE) by the first user equipment (UE) in a wireless communication system comprising:
receiving, by the first user equipment (UE), a first signal and a second signal from the second user equipment (UE); and
measuring, by the first user equipment (UE), the distance between the second user equipment (UE) and the first user equipment (UE) based on the first signal and the second signal,
wherein
the distance is measured based on a first transmission angle, a second transmission angle, a first reception angle, a second reception angle, and a time difference between a first reception time point where the first user equipment (UE) receives the first signal and a second reception time point where the first user equipment (UE) receives the second signal.

2. The method according to claim 1, wherein:
the first transmission angle is an angle between a first reference axis and a path along which the first signal is transmitted from the second user equipment (UE);
the second transmission angle is an angle between the first reference axis and a path along which the second signal is transmitted from the second user equipment (UE);
the first reception angle is an angle between a second reference axis and a path along which the first signal is received by the first user equipment (UE); and
the second reception angle is an angle between the second reference axis and a path along which the second signal is received by the first user equipment (UE).

3. The method according to claim 2, wherein:
the distance is measured using a following equation:
$$d = \frac{c \cdot {t}_{0 , 1}}{\frac{sin ( {θ}_{T , 0} - {θ}_{T , 1} ) + sin ( {θ}_{R , 0} - {θ}_{R , 1} )}{sin ( π - ( {θ}_{T , 0} - {θ}_{T , 1} + {θ}_{R , 0} - {θ}_{R , 1} ) )} - 1} \qquad [ Equation ]$$
where, c is speed of light, t_{0,1} is a time difference between the first reception time point and the second reception time point, θ_{T,0} is the first transmission angle, θ_{T,1} is the second transmission angle, θ_{R,0} is the first reception angle, and θ_{R,1} is the second reception angle.

4. The method according to claim 1, wherein:
if the first signal and the second signal are transmitted along a none-line-of-sight (NLOS) path, the first user equipment (UE) considers that the second signal is transmitted along a line-of-sight (LOS) path; and
a predetermined offset is applied to the distance.

5. The method according to claim 4, wherein:
the offset is determined differently according to an angle-of-arrival (AoA) value or an angle-of-departure (AoD) value.

6. The method according to claim 1, wherein:
the first signal is transmitted along a none-line-of-sight (NLOS) path; and
the second signal is transmitted along a line-of-sight (LOS) path.

7. The method according to claim 2, wherein:
information about whether the first signal and the second signal are transmitted along a line-of-sight (LOS) path is determined through phase distribution of channel components related to a positioning reference signal (PRS).

8. The method according to claim 1, further comprising:
receiving, by the first user equipment (UE), information indicating either a first reference axis or a second reference axis from the second user equipment (UE); or
transmitting, by the first user equipment (UE), information indicating either the first reference axis or the second reference axis to the second user equipment (UE).

9. The method according to claim 1, further comprising:
if the first user equipment (UE) does not acquire the first transmission angle or the second transmission angle,
transmitting, by the first user equipment (UE), a feedback signal including information about the first reception angle and information about the second reception angle to the second user equipment (UE),
wherein the distance is measured by the second user equipment (UE).

10. A first user equipment (UE) for measuring a distance between the first user equipment (UE) and the second user equipment (UE) as well as a position of the second position in a wireless communication system comprising:
a memory; and
a processor connected to the memory,
wherein
the processor is configured to:
receive a first signal and a second signal from the second user equipment (UE); and
measure the distance between the second user equipment (UE) and the first user equipment (UE) based on the first signal and the second signal,
wherein
the distance is measured based on a first transmission angle, a second transmission angle, a first reception angle, a second reception angle, and a time difference between a first reception time point where the first user equipment (UE) receives the first signal and a second reception time point where the first user equipment (UE) receives the second signal.

11. The first user equipment (UE) according to claim 10, wherein:
the first user equipment (UE) is configured to communicate with at least one of a mobile user equipment (UE), a network, and an autonomous vehicle other than the device.

12. The first user equipment (UE) according to claim 10, wherein:
the first user equipment (UE) is configured to implement at least one advanced driver assistance system (ADAS) function based on a signal for controlling movement of the first user equipment (UE).

13. The first user equipment (UE) according to claim 10, wherein:
the first user equipment (UE) receives a user input signal from a user, switches a driving mode of the device from an autonomous driving mode to a manual driving mode, or switches a driving mode of the device from the manual driving mode to the autonomous driving mode.

14. The first user equipment (UE) according to claim 10, wherein:
the first user equipment (UE) is autonomously driven based on external object information,
wherein the external object information includes at least one of information indicating presence or absence of an object, position information of the object, information about a distance between the first user equipment (UE) and the object, and information about a relative speed between the first user equipment (UE) and the object.
